(19) United States
(12) Patent Application Publication
(10) Pub. No.: US 2010/0136234 A1
(43) Pub. Date: Jun. 3, 2010

(54) INKJET RECORDING METHOD

(75) Inventor: Masamichi KOBAYASHI, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/626,623

(22) Filed: Nov. 26, 2009

(30) Foreign Application Priority Data
Dec. 2, 2008 (JP) 2008-307835

(51) Int. Cl. B05D 5/00

(52) U.S. Cl. 427/256

(57) ABSTRACT

Images are recorded by using a magenta ink and a cyan ink including a cyan dye containing 50% by mass or more of a phthalocyanine dye represented by the following Formula (C-1) on an inkjet recording medium having at least two ink receiving layers provided on or above a substrate, wherein at least one layer of the at least two ink receiving layers comprises a basic compound, an uppermost layer that is farthest from the substrate among the at least the two ink receiving layers comprises pseudo boehmite alumina, a binder, and a water-soluble high-boiling solvent, and a lower layer provided between the uppermost layer and the substrate comprises inorganic fine particles, a binder, and at least one of a cationic polyurethane or a zirconium salt.

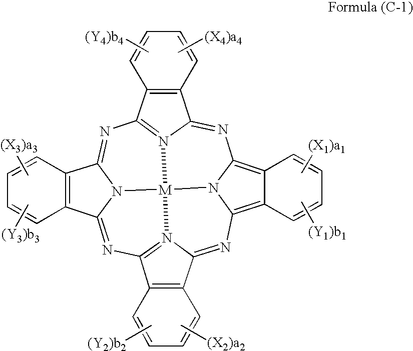

### CROSS-REFERENCE TO RELATED APPLICATION

This application is based on and claims priority under 35 USC 119 from Japanese Patent Application No. 2008-307835 filed on Dec. 2, 2008, the disclosure of which is incorporated herein by reference in its entirety.

### BACKGROUND OF THE INVENTION

1. Field of the Invention

The present invention relates to an inkjet recording method.

2. Description of the Related Art

Following rapid progress in the field of information technology in recent years, information processing systems of various kinds have been developed and recording methods and recording devices suitable for each information processing system have been put to practical use. Among these, inkjet recording methods are widely used because recording is possible on recording media of various types, the hardware (devices) are comparatively inexpensive and compact, and a very low level of noise is generated. Furthermore, with recording using the inkjet recording medium, a recorded image of so-called “photo-like” quality can be obtained.

A recording medium for inkjet recording is typically required to have the following properties: (1) fast drying ability (high ink absorption rate); (2) appropriate and uniform dot diameter (no bleeding); (3) good graininess; (4) high roundness of dots; (5) high color density; (6) high color saturation (no dullness); (7) good water resistance, light fastness, and ozone resistance of the image portion; (8) high whiteness; (9) high storage stability (no yellowing discoloration or image bleeding in long-term storage); (10) resistance to deformation and good dimensional stability (low degree of curling); and (11) good hardware running ability.

In consideration of the above-described requirements, an inkjet recording medium in which a layer receiving an ink (ink-receiving layer) has a porous structure has been put to practical use and has been an object of various research in recent years.

For example, a feature of introducing a water-soluble polyvalent metal salt and an aqueous dispersion of a cation-modified polymer in the ink-receiving layer with the object of improving resistance to bleeding over time (see, for example, JP-A No. 2006-15655) and a feature of introducing an aqueous dispersion of a polymer with a glass transition temperature of equal to or less than 50° C. and an average particle size of equal to or less than 0.05 μm with the object of improving print density and reducing bleeding with the passage of time and brittleness (see, for example, JP-A No. 2006-264190) are known.

Furthermore, a feature of introducing alumina or an alumina hydrate into an ink-receiving layer with the object of improving bronzing and increasing the absorption rate, water resistance, and coloring ability is known, wherein an average secondary particle size of the alumina or alumina hydrate is 80-300 nm, an average primary particle size is 3-50 nm, and the probability of presence of a particle in a primary particle state is equal to or less than 10% (see, for example, JP-A No. 2005-254588).

A feature of introducing an alumina hydrate into an upper layer of an ink-receiving layer, without introducing a cationic compound other than alumina hydrate, and introducing fine particle silica, a water-soluble zirconium compound, and cationic polymer into a lower layer of the ink-receiving layer with the object of reducing bronzing and bleeding is also known (see, for example, JP-A No. 2005-262716).

However, when the ink-receiving layers described in JP-A Nos. 2006-15655, 2006-264190, and 2005-254588 are used, print density sometimes decreases. When the ink-receiving layer described in JP-A No. 2005-262716 is used, in some cases, it is impossible both to increase the print density and to reduce bronzing. Further, when inkjet recording is performed on such an ink-receiving layer containing alumina hydrate as the ink-receiving layer described in the above patent publication, light fastness and ozone resistance of the recorded image may decrease.

### SUMMARY OF THE INVENTION

The present invention was created with consideration for the above-described problems and it provides an inkjet recording method.

According to the first aspect of the invention, there is provided the following inkjet recording method.

<1> An inkjet recording method, including recording an image by an inkjet system using an ink set having a magenta ink and a cyan ink containing a cyan dye containing 50 mass % or more of a compound represented by the following Formula (C-1) on an inkjet recording medium having at least two ink receiving layers provided on or above a substrate, wherein at least one layer of the at least two ink receiving layers contains a basic compound, an uppermost layer that is farthest from the substrate among the at least the two ink receiving layers contains pseudo boehmite alumina, a binder, and a water-soluble high-boiling solvent, and a lower layer provided between the uppermost layer and the substrate contains inorganic fine particles, a binder, and at least one of a cationic polyurethane or a zirconium salt.

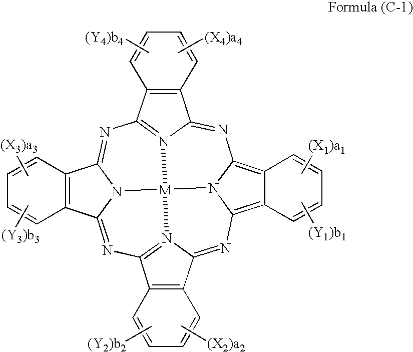

In the formula (C-1), X₁, X₂, X₃, and X₄ each independently represent any of —SO—Z, —SO₂—Z, —SO₂NV₁V₂, —CONV₁V₂, —CO₂Z, —CO—Z, and a sulfo group.

In the formula (C-1), Z′s each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

V₁ and V₂ may be the same or different and each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group. Each group may further have a substituent.

a₁ to a₄ and b₁ to b₄ each represent the number of substituents of X₁ to X₄ and Y₁ to Y₄, respectively, provided that a₁ to a₄ each independently represent an integer of from 0 to 4 and are not all 0 at the same time and b₁ to b₄ each independently represent an integer of from 0 to 4.

M represents a hydrogen atom, a metal atom, oxides thereof, hydroxides thereof, or halides thereof, provided that at least one of X₁, X₂, X₃, X₄, Y₁, Y₂, Y₃, or Y₄ is an ionic hydrophilic group or a group having an ionic hydrophilic group as a substituent.

### DETAILED DESCRIPTION OF THE INVENTION

Hereinafter, specific exemplary embodiments of the present invention will be described in detail.

<2> The inkjet recording method according to <1>, wherein the basic compound is contained in the uppermost layer that is farthest from the substrate.
<3> The inkjet recording method according to <1> or <2>, wherein at least one of the at least two ink receiving layers comprises an organic compound having a sulfo group.
<4> The inkjet recording method according to <3>, wherein the organic compound having a sulfo group comprises a naphthalene ring.
<5> The inkjet recording method according to any one of <1> to <4>, wherein the compound represented by the above-described Formula (C-1) is a compound represented by the below-described Formula (C-2) or a salt thereof.
<6> The inkjet recording method according to <5>, wherein the compound represented by the below-described Formula (C-2) is a compound selected from the group consisting of a compound represented by the below-described Formula (C-3) and a salt thereof.
<7> The inkjet recording method according to <6>, wherein, in Formula (C-3), l, m, n, and p each independently represents an integer of 1 or 2 and at least two of l, m, n, and p are 1.
<8> The inkjet recording method according to <6>, wherein, in Formula (C-3), l, m, n, and p are each 1.
<9> The inkjet recording method according to <6>, wherein, in Formula (C-3), Z₁, Z₂, Z₃, and Z₄ each independently represent Z₁₁ that represents —(CH₂)₃SO₃M₂ wherein M₂ represents an alkali metal atom, or Z₁₂ that represents —(CH₂)₃SO₂NHCH₂CH(OH)CH₃.
<10> The inkjet recording method according to <6>, wherein, in Formula (C-3), M is Cu, and M₂ is Li.
<11> The inkjet recording method according to any one of <1> to <10>, wherein no cationic polyurethane is contained in the uppermost layer that is farthest from the substrate.
<12> The inkjet recording method according to any one of <1> to <11>, wherein no water-soluble high-boiling solvent is contained in the lower layer among the at least the two ink receiving layers.

The present invention can provide an inkjet recording method that gives excellent image printing density, is capable of suppressing bleeding and bronzing, and gives excellent ozone resistance and light fastness.

Inkjet Recording Method

The inkjet recording method of the present invention include a step of recording an image by an inkjet system using an ink set having a magenta ink and a cyan ink containing a cyan dye containing 50 mass % or more of a compound represented by the below-described formula (C-1) on the below-described inkjet recording medium.

It is possible to increase a print image density, to suppress bleeding and bronzing, and to enhance ozone resistance and light fastness by the inkjet recording method having the above-described constitution of the present invention. Especially, bleeding of the magenta ink can be suppressed and both ozone resistance and light fastness of the cyan ink can be improved by the inkjet recording method.

The inkjet recording medium and a production method thereof, the ink set and the inkjet system that each constitutes the inkjet recording method are described in detail below.

Ink Jet Recording Medium

The inkjet recording medium in accordance with the present invention has at least two ink-receiving layers on a substrate; at least one of the at least two ink-receiving layers includes a basic compound; among the at least two ink-receiving layers, an uppermost layer that is the farthest from the substrate includes pseudoboehmite alumina, a binder, and a water-soluble high-boiling solvent, and a lower layer provided between the uppermost layer and the substrate comprises inorganic fine particles, a binder, and a cationic polyurethane and/or a zirconium salt.

Pseudoboehmite alumina is a component contributing to an increase in print density, but bronzing sometimes occurs in ink-receiving layers including pseudoboehmite alumina.

Adding a water-soluble high-boiling solvent and a basic compound to an ink-receiving layer including pseudoboehmite alumina is an effective method for inhibiting bronzing, but the addition of water-soluble high-boiling solvent deteriorates bleeding. Adding a cationic polyurethane or a zirconium salt is effective in inhibiting bleeding, but print density decreases when a cationic polyurethane or zirconium salt is added to an ink-receiving layer including pseudoboehmite alumina.

Thus, print density can be increased and at the same time bleeding can be inhibited by providing an ink-receiving layer in which a cationic polyurethane and/or a zirconium salt is present in a lower layer of the ink-receiving layer including pseudoboehmite alumina.

Therefore, by configuring an inkjet recording medium according to the invention, it is possible to increase print density and inhibit bleeding and bronzing.

Furthermore, when an ink-receiving layer has a single-layer configuration, more specifically, when a water-soluble high-boiling solvent and a cationic polyurethane are contained in the same ink-receiving layer, the ink-receiving layer sometimes shrinks during coating and drying and the layer formation becomes difficult (that is, suitability for coating decreases).

Therefore, the invention also provides good suitability for coating.

In accordance with the invention, the basic compound may be contained in at least one layer from among the at least two ink-receiving layers.

From the standpoint of obtaining the effect of the invention more effectively, it is preferred that the basic compound is contained in the uppermost layer of the at least two ink-receiving layers.

Ink-Receiving Layer

The inkjet recording medium in accordance with the invention has at least two ink-receiving layers on or above a substrate.

The at least two ink-receiving layers are not particularly limited, provided that they include an uppermost layer that is the farthest from the substrate and a lower layer provided between the uppermost layer and the substrate. If necessary, another layer (intermediate layer or the like) may be contained between the uppermost layer and the lower layer, or between the lower layer and the substrate.

Uppermost Layer

The uppermost layer in accordance with the invention includes pseudoboehmite alumina, a binder, and a water-soluble high-boiling solvent. If necessary, the uppermost layer may contain other components. However, from the standpoint of further inhibiting the drying-induced shrinkage of the ink-receiving layer, it is preferred that the uppermost layer does not contain any cationic polyurethane described below.

From the standpoint of obtaining the effect of the invention more effectively, it is further preferred that the uppermost layer in accordance with the invention include a basic compound.

The coating amount of the pseudoboehmite alumina of the uppermost layer is not particularly limited, but from the standpoint of ink absorption ability and coloring ability, it is preferred that this coating amount is from 10 to 30 g/m², and more preferably from 15 to 25 g/m².

The aforementioned components contained in the uppermost layer will be described in greater detail below.

Lower Layer

The lower layer in accordance with the invention includes inorganic fine particles, a binder, a cationic polyurethane and/or a zirconium salt. If necessary, the lower layer may contain other components. However, from the standpoint of further inhibiting the drying-induced shrinkage of the ink-receiving layer, it is preferred that the lower layer does not contain any water-soluble high-boiling solvent described below.

The lower layer may have a single-layer configuration or may be configured of two or more layers.

The coating amount of the inorganic fine particles of the lower layer (in the case of two or more layers, the total coating amount) is not particularly limited, but from the standpoint of ink absorption ability and coating ability, this coating amount is preferably from 9 to 30 g/m², and more preferably from 15 to 25 g/m².

The aforementioned components contained in the lower layer will be described in greater detail below.

In accordance with the invention, from the standpoint of obtaining the bronzing inhibition effect more effectively, it is preferred that the layer ratio (%) of the uppermost layer represented by Formula A below be adjusted.

Layer ratio(%)of uppermost layer=((Coating amount(weight)of pseudoboehmite alumina of the uppermost layer)/(Coating amount(weight)of pseudoboehmite alumina of the uppermost layer)+(Coating amount(weight)of inorganic fine particles of the lower layer))×100 Formula A.

More specifically, from the standpoint of obtaining the bronzing inhibition effect more effectively, it is preferred that the layer ratio (%) of the uppermost layer be equal to or more than 10%, more preferably equal to or more than 30%, and even more preferably equal to or more than 40%.

The upper limit of the layer ratio (%) of the uppermost layer is not limited, but preferably 60%.

The components contained in the ink-receiving layer in accordance with the invention will be described below.

### Basic Compound

At least one layer (preferably, the uppermost layer) among the ink-receiving layers in accordance with the invention includes a basic compound.

Examples of suitable basic compounds include alcoholamines such as ethanolamine or triethanolamine; volatile bases such as ammonia; inorganic alkali agents, for example, alkali metal hydroxides such as sodium hydroxide, potassium hydroxide, or lithium hydroxide, and sodium acetate; and basic amino acids such as guanidine.

With consideration for preserving properties of image-receiving paper (resistance to bleeding under the conditions of moisture and heat), a volatile base or a basic amino acid is preferred as the basic compound, and ammonia and guanidine are especially preferred.

The content of the basic compound in accordance with the invention is not particularly limited, but from the standpoint of obtaining the effect of the invention more effectively, it is preferred that this content be from 0.01 to 0.3 wt. %, and more preferably from 0.02 to 0.1 wt. % relative to the total amount of solids in all the ink-receiving layers (all the layers including the uppermost layer and the lower layer).

Pseudoboehmite Alumina

The ink-receiving layer (at least the uppermost layer; if necessary, the lower layer or other layers) includes at least one pseudoboehmite alumina.

The pseudoboehmite alumina in accordance with the invention is an alumina hydrate represented by a structural formula Al₂O₃.nH₂O (1<n<3) wherein n is larger than 1 and less than 3.

Crystalline or amorphous pseudoboehmite alumina of irregular shape or of a spherical or plate-like shape can be used as the pseudoboehmite alumina. One pseudoboehmite alumina may be used, or two or more pseudoboehmite alumina may be used together.

Pseudoboehmite alumina of a plate-like or rod-like shape with an aspect ratio equal to or larger than 2 is particularly preferred.

A method of producing pseudoboehmite alumina is not particularly limited, and pseudoboehmite alumina can be produced, for example, by a well-known method such as hydrolysis of an aluminum alkoxide such as aluminum isopropoxide, neutralization of an aluminum salt with an alkali, or hydrolysis of an aluminate.

Commercial products of pseudoboehmite alumina are available, for example, from Nissan Chemical Industries, Ltd., Shokubai Kasei Kogyo Kabushiki Kaisha, Sasol Ltd., and Martinswerk Co.

The average particle size of primary particles of pseudoboehmite alumina in accordance with the invention is not particularly limited, but an average particle size equal to or less than 100 nm is preferred, from 5 to 50 nm is more preferred, and from 8 to 30 nm is especially preferred.

The average particle size of the primary particles is obtained by respectively determining the diameter of a circle having an area equal to the projected area of each of 100 particles present in a given area when the dispersed particles are observed under an electron microscope, and calculating the average diameter thereof.

An average particle size of secondary particles of pseudoboehmite alumina in accordance with the invention is not particularly limited, but an average particle size of from 80 to 250 nm is preferred, and from 120 to 200 nm is more preferred.

When the average particle size of secondary particles is within the aforementioned ranges, ink absorption ability and surface gloss are further improved.

The average particle size of secondary particles can be measured with a particle size distribution measurement device of a laser diffraction/scattering type or with a particle system distribution measurement device of a dynamic light scattering type by diluting a dispersion of alumina hydroxide to a concentration of solids equal to or less than 2%. The particle size of secondary particles is governed by dispersibility of alumina hydroxide, but can be adjusted to a certain degree by changing the amount of a deflocculating agent added or concentration of solids.

The pseudoboehmite alumina in accordance with the invention is preferably used in the form of a pseudoboehmite alumina dispersion.

Well-known dispersers such as a toothed-blade disperser, propeller impeller disperser, a high-pressure homogenizer, an ultrasound disperser, and a beads mill can be used for dispersing pseudoboehmite alumina.

When pseudoboehmite alumina is dispersed, a dispersion aid is preferably used.

Acids such as lactic acid, acetic acid, formic acid, nitric acid, hydrochloric acid, hydrobromic acid, or aluminum chloride can be used as the dispersion aid. Among them, inorganic acids are preferred because they have higher low-temperature viscosity.

The amount of the dispersion aid added is preferably from 0.1 to 5 wt. % relative to the pseudoboehmite alumina.

Where pseudoboehmite alumina dispersed in an acid is used, coating liquid properties are good and coating ability is also good even when boric acid or a borate is employed as a hardener (crosslinking agent). As a result, white paper glossiness and ink absorption ability are good.

A concentration of solids in the pseudoboehmite alumina dispersion used in accordance with the invention is preferably from 10 to 35 wt. %, and more preferably from 20 to 30 wt. %, in terms of the amount of Al₂O₃.

It is preferable that the pseudoboehmite alumina in accordance with the invention has a cationic surface. As a result, a fixing effect of a colorant such as a dye used in the ink is increased and the amount of a dye mordant such as a cationic polymer that is added can be decreased or reduced to zero.

From the standpoint of obtaining the effect of the invention more effectively, it is preferred that the content of pseudoboehmite alumina in the ink-receiving layer in accordance with the invention be from 40 to 90 wt. %, and more preferably from 50 to 80 wt. % relative to the total amount of solids in the ink-receiving layer (for example, the uppermost layer) including the pseudoboehmite alumina.

Inorganic Fine Particles

The ink-receiving layer in accordance with the invention (at least the lower layer; if necessary, the uppermost layer or other layers) includes at least one species of inorganic fine particles.

Examples of suitable inorganic fine particles include fine particle silica, colloidal silica, titanium dioxide, barium sulfate, calcium silicate, zeolites, kaolinite, halloysite, mica, talc, calcium carbonate, magnesium carbonate, calcium sulfate, boehmite alumina, and pseudoboehmite alumina.

Among them, pseudoboehmite alumina and fine particle silica are preferred as inorganic fine particles of the lower layer. The pseudoboehmite alumina referred to here is the same as described above, and the preferred ranges are also the same.

Because the aforementioned fine particle silica has an especially high specific surface area, ink can be absorbed and retained with high efficiency. Furthermore, because a refractive index of fine particle silica is low, the ink-receiving layer can be imparted with transparency and high color density and good coloring ability can be obtained, provided that dispersion is performed to an adequate fine particle diameter. Such a transparency of the ink-receiving layer is important not only for applications requiring transparency, such as OHP, but also from the standpoint of obtaining high color density and good coloring ability and gloss also in applications to a recording sheet such as a photoglossy paper.

Synthetic silica can be advantageously used as the fine particle silica.

The synthetic silica can be generally classified into a vapor-phase silica and wet silica, depending on the manufacturing method thereof.

The vapor-phase silica is also called dry silica and is generally produced by a flame hydrolysis method. More specifically, a production method is generally known in which silicon tetrachloride is combusted together with hydrogen and oxygen, but silanes such as methyltrichlorosilane or trichlorosilane can be also used individually instead of the silicon tetrachloride or in a mixture with silicon tetrachloride. Vapor-phase silica is marketed as AEROSIL by Japan Aerosil Co., Ltd. and QS type by Tokuyama KK and can be purchased therefrom.

An average primary particle size of the vapor-phase silica is preferably from 5 to 50 nm. In order to obtain a higher gloss, a vapor-phase silica with an average primary particle size of from 5 to 20 nm and a specific surface area of from 90 to 400 m²/g that are determined by a BET method is preferred. The BET method as referred to in the present invention is a method for measuring a surface area of a powder by a vapor-phase adsorption method. By this method, a total surface area of 1 g of a sample, that is, a specific surface area is obtained from an adsorption isotherm. Nitrogen gas is ordinarily used as the adsorption gas, and a method of measuring an adsorption amount of gas from the pressure or volume variations of adsorbed gas is most often used. An equation created by Brunauer, Emmett, and Teller, which is called a BET equation, is most famous for the equation that is used to represent an isotherm of multimolecular adsorption and it has been widely used for determining the surface area. A surface area can be obtained by measuring the adsorption amount based on the BET equation and multiplying by the area occupied by one molecule adsorbed on the surface.

As described hereinabove, in vapor-phase silica, primary particles having a size of from several nanometers to several tens of nanometers can be present in a state in which they form a network structure or are joined in chain-like two-dimensional aggregates. It is preferred that dispersing be performed so as to obtain an average particle size of aggregated particles of equal to or less than 500 nm, more preferably equal to or less than 300 nm. The lower limit for the particle size is about 50 nm. The average particle size of aggregated particles can be obtained from a transmission electron micrograph, but can be also measured in a simple manner as a number-median diameter using a Particle Size Distribution Analyzer of a laser diffraction/scattering type (for example, LA910 manufactured by Horiba, Ltd.).

Depending on the manufacturing method, wet silica can be further classified into precipitation method silica, gel method silica, and sol method silica. The precipitation method silica is manufactured by reacting sodium silicate and sulfuric acid under alkali conditions. Silica particles produced and grown in the manufacturing process aggregate and precipitate. The product is obtained through subsequent manufacturing processes of filtration, washing with water, drying, grinding, and classification. Secondary particles of silica manufactured by this method become loose aggregated particles, and particles that are comparatively easy to grind can be obtained. Examples of commercially available precipitation method silica include NIPSIL marketed by Toso Silica Co., Ltd. and TOKUSIL and FINESIL marketed by Tokuyama Co.

Gel method silica is manufactured by reacting sodium silicate and sulfuric acid under acidic conditions. In this case, small silica particles dissolve during an aging process and re-precipitate between large primary particles, thereby bonding the primary particles together. As a result, distinct primary particles disappear and comparatively hard-agglomerated particles having a structure with internal cavities are formed. Examples of commercial products include MIZUCASIL marketed by Mizusawa Chemical Industries, Ltd. and SILOJET marketed by Grace Japan Co.).

Sol method silica is also called colloidal silica. The sol method silica is obtained by heating and maturing silica sol obtained by double decomposition of sodium silicate with an acid or through an ion-exchange resin layer. For example, SNOWTEX is marketed by Nissan Chemical Industries Co., Ltd. as sol method silica.

Precipitation method silica or gel method silica are preferred as the wet silica. An average particle size (average secondary particle size) of wet silica of these types is usually equal to or higher than 1 μm. Wet silica of these types is preferably ground to an average particle size of equal to or less than 500 nm, more preferably equal to or less than 300 nm. The lower limit for the particle size is about 50 nm. A particle diameter of the ground wet silica can be obtained, as described hereinabove, using a laser diffraction/scattering type transmission electron microscope or a particle size distribution analyzer.

A process for grinding the wet silica preferably includes a primary dispersion step in which fine particle silica is added to a dispersion medium and mixed therewith (preliminary dispersing) and a secondary dispersion step in which silica contained in a coarse dispersion obtained in the primary dispersion step is ground. Preliminary dispersing in the primary dispersion step can be performed by ordinary propeller stirring, a toothed blade disperser, turbine type stirring, homo-mixer type stirring, and ultrasonic stirring. A wet dispersing method in which silica dispersed in a dispersion medium is mechanically ground can be advantageously used as a grinding method for wet silica. Examples of suitable wet dispersers include media mills such as a ball mill, a beads mill, and a sand grinder, pressure dispersers such as a high-pressure homogenizer and an ultrahigh-pressure homogenizer, an ultrasonic disperser, and a thin-film rotary-type disperser. A media mill such as a beads mill is especially preferred in the invention.

The wet silica preferably has an average particle size (average secondary particle size) of equal to or more than 5 μm. A higher density of dispersion can be obtained by grinding silica with a comparatively large particle size. The upper limit of the average particle size of wet silica used in accordance with the invention is not particularly limited, but an average particle size of wet silica is usually equal to or less than 200 μm.

Precipitation method silica is preferred as the wet silica. As described hereinabove, in precipitation silica, secondary particles are loose aggregated particles and, therefore, are advantageous for grinding.

In the invention, it is preferred that fine particle silica be cationized by adding a cationic compound. A cationic polymer, a water-soluble polyvalent metal compound, or a silane coupling agent can be used as the cationic compound. Among these cationic compounds, cationic polymers and water-soluble polyvalent metal compounds are preferred and cationic polymers are especially preferred.

A water-soluble cationic polymer having an acid adduct of a quaternary ammonium group, a phosphonium group, or a primary to tertiary amine is exemplified as a cationic polymer that can be used in the invention. Examples of such polymers include polyethyleneimines, polydialkyldiallylamines, polyallylamines, alkylamine epichlorohydrin polycondensates, and cationic polymers described in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411, and 10-193776, and WO 99/64248. A weight-average molecular weight of the cationic polymer used in accordance with the invention is preferably equal to or less than 100,000, more preferably equal to or less than 50,000, and even more preferably 2,000 to about 30,000.

An amount of the cationic polymer in accordance with the invention is preferably within a range of 1 to 10 wt. % in relation to fine particle silica.

From the standpoint of obtaining the effect of the invention more effectively, content of inorganic fine particles in the ink-receiving layer in accordance with the invention is preferably from 0.5 to 10 wt. %, and more preferably from 1 to 8 wt. % in relation to the total amount of solids in the ink-receiving layer (for example, the lower layer) including the inorganic fine particles.

Binder

The ink-receiving layer (at least the uppermost layer and lower layer and, if necessary, other layers) in accordance with the invention includes at least one binder.

A variety of heretofore known binders can be used as the binder, but a hydrophilic binder having high transparency and higher ink permeability in combination is preferably used. When a hydrophilic binder is used, it is important that the hydrophilic binder does not close pores due to swelling during initial permeation of the ink. From this standpoint, a hydrophilic binder with a low degree of swelling at a temperature comparatively close to room temperature is advantageously used. An especially preferred hydrophilic binder is a completely or partially saponified poly (vinyl alcohol) or cation-modified poly(vinyl alcohol).

A partially or completely saponified poly(vinyl alcohol) with a degree of saponification of equal to or more than 80% is especially preferred as the poly(vinyl alcohol). An average degree of polymerization thereof is preferably 200-5000.

Examples of a cation-modified polyvinyl alcohol include a poly(vinyl alcohol) having a primary to tertiary amino group or a quaternary ammonium group in the main chain or side chain of the poly(vinyl alcohol), as described, for example, in JP-A No. 61-10483.

From the standpoint of obtaining the effect of the invention more effectively, it is preferred that the content of the binder in the ink-receiving layer in accordance with the invention be from 5 to 30 wt. %, and more preferably from 7 to 20 wt. % in relation to the total amount of solids in the ink-receiving layer (for example, the uppermost layer or the lower layer) including the binder.

Water-Soluble High-Boiling Solvent

The ink-receiving layer (at least the uppermost layer; if necessary, the lower layer or other layers) in accordance with the invention includes at least one water-soluble high-boiling solvent.

By including a water-soluble high-boiling solvent, it is possible to inhibit bronzing. Furthermore, curing of a recording medium can be also inhibited.

“High-boiling” as referred to herein means a boiling point equal to or higher than 120° C. under normal pressure.

The “water-soluble” as used herein means an ability to be dissolved to 1 wt. % or more in water at normal temperature and under normal pressure.

The boiling point of the water-soluble high-boiling solvent under normal pressure is more preferably equal to or higher than 150° C., and even more preferably equal to or higher than 180° C.

Examples of the water-soluble high-boiling solvent include alcohols such as ethylene glycol, propylene glycol, diethylene glycol, triethylene glycol, glycerin, diethylene glycol monobutyl ether (DEGMBE), diethylene glycol monohexyl ether (DEGMHE), triethylene glycol monobutyl ether (TEGMBE), glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol (weight-average molecular weight is equal to or less than 400).

From the standpoint of inhibiting bronzing, high-boiling ether solvents are preferred as the water-soluble high-boiling solvent in accordance with the invention. Among these solvents, diethylene glycol monobutyl ether (DEGMBE), diethylene glycol monohexyl ether (DEGMHE), and triethylene glycol monobutyl ether (TEGMBE) are even more preferred.

The content of the water-soluble high-boiling solvent in the coating liquid for forming the ink-receiving layer (for example, the below-described coating liquid B) is preferably from 0.05 to 1% by weight, and especially preferably from 0.1 to 0.6% by weight.

Cationic Polyurethane

The ink-receiving layer (at least the lower layer; if necessary other layers) in accordance with the invention includes a cationic polyurethane and/or a zirconium salt.

The cationic polyurethane is polyurethane having a cationic group.

Examples of the cationic polyurethane include polyurethanes synthesized by performing polyaddition reaction between the below-described diol compounds and the below-described diisocyanate compounds in various combinations.

Specific examples of the diol compounds include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycol (average molecular weight is equal to 200, 300, 400, 600, 1000, 1500, 4000), polypropylene glycol (average molecular weight is equal to 200, 400, 1000), polyesterpolyols, 4,4′-dihydroxydiphenyl-2,2-propane, and 4,4′-dihydroxyphenylsulfone.

Examples of the diisocyanate compounds include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3-dimethyl-4,4′-diphenylmethane diisocyanate, 3,3′-dimethylbiphenylene diisocyanate, 4,4′-biphenylene diisocyanate, dicyclohexylmethane diisocyanate, and methylenebis (4-cyclohexylisocyanate).

Examples of the cationic groups contained in the cationic polyurethane in accordance with the invention include primary to tertiary amino groups and quaternary ammonium salts.

A cationic polyurethane having a cationic group such as a tertiary amino group or a quaternary ammonium salt is preferred as the cationic polyurethane in accordance with the invention.

The cationic polyurethane can be obtained, for example, by using a compound obtained by introducing a cationic group into a diol as described above when the polyurethane is synthesized. In the case of a quaternary ammonium salt, the polyurethane having a tertiary amino group may be quaternized with a quaternizing agent.

One diol compound and one diisocyanate compound may be used for synthesizing the polyurethane. Alternatively, two or more diol compounds and/or two or more diisocyanate compounds may be combined and used at arbitrary ratios according to various objects (for example, in order to adjust glass transition temperature (Tg) of the polymer, or to increase solubility of the polymer, or to provide compatibility with the binder, or to improve dispersion stability).

Examples of commercial products of dispersions of the cationic polyurethanes include “SUPERFLEX 650”, “SUPERFLEX 650-5”, “F-8564D”, and “F-8570D” manufactured by Dai-ichi Kogyo Seiyaku Co., Ltd., and “NEOFIX IJ-150” manufactured by Nicca Chemical Co., Ltd.

The content of cationic groups in the cationic polyurethane is preferably from 0.1 to 5 mmol/g, and more preferably from 0.2 to 3 mmol/g. Where the content of cationic groups is equal to or more than 0.1 mmol/g, the dispersion stability of the polymer can be further improved, and when the content of cationic groups is equal to or less than 5 mmol/g, compatibility with the binder can be further improved.

A glass transition temperature of the cationic polyurethane when it is used in an ink-receiving layer is not particularly limited, but is preferably within the following range.

In order to suppres image bleeding with aging over a long period after the image has been formed by inkjet recording and also to improve dimensional stability (resistance to curling), it is preferred that the glass transition temperature of the cationic polyurethane be less than 50° C. It is more preferred that the glass transition temperature of the cationic polyurethane be equal to or less than 30° C. and still more preferred that it be equal to or less than 15° C.

The lower limit of the glass transition temperature is not particularly limited, but from the standpoint of suitability for production during preparation of an aqueous dispersion, the glass transition temperature is about −30° C. in usual applications.

Usually, the weight-average molecular weight (Mw) of the cationic polyurethane is preferably from 1000 to 200,000, and more preferably from 2000 to 50,000. When the molecular weight is equal to or higher than 1000, a more stable aqueous dispersion can be obtained. Furthermore, when the molecular weight is equal to or less than 200,000, solubility can be further increased, liquid viscosity can be further decreased, and an average particle size of aqueous dispersion can be further decreased (for example, the average particle size may be controlled to a value equal to or less than 0.05 μm).

When the ink-receiving layer in accordance with the invention includes the cationic polyurethane, the content of the cationic polyurethane is preferably from 0.1 to 30% by weight, more preferably from 0.3 to 20% by weight, and most preferably from 0.5 to 15% by weight based on the total amount of solids in the ink-receiving layer (for example, the lower layer) including the cationic polyurethane. When this content is equal to or higher than 0.1% by weight, reduction of bleeding with aging can be achieved more effectively. When the content is equal to or less than 30% by weight, the proportion of fine particles and binder component increases and ink absorption ability can be further increased.

A method for preparing an aqueous dispersion of the cationic polyurethane will be described below.

An aqueous dispersion with an average particle size of equal to or less than 0.05 μm can be obtained by mixing the cationic polyurethane with an aqueous solvent, if necessary, also with additives to prepare a mixture, and making the mixture grain refining by using a disperser. A variety of hitherto known dispersers such as a high-speed rotary disperser, a medium-stirring disperser (a ball mill, a sand mill, a beads mill, and the like), an ultrasonic disperser, a colloid mill disperser, or a high-pressure disperser can be used as the disperser for obtaining the aqueous dispersion. From the standpoint of efficiently dispersing the obtained ball-shaped fine particles, the medium-stirring disperser, the colloid mill disperser, or the high-pressure disperser is preferred.

A detailed structure of the high-speed disperser (homogenizer) is described in U.S. Pat. No. 4,533,254 and JP-A No. 6-47264. Examples of suitable commercial products include a GAULIN HOMOGENIZER (A. P. V. Gaulin Inc.), MICROFLUIDIZER (Microfluidex Inc.), and ULTIMIZER (Sugino Machine KK). A high-pressure homogenizer equipped with a mechanism for atomization in an ultrahigh-pressure jet flow, as described in U.S. Pat. No. 5,720,551 is especially effective for emulsifying and dispersing in accordance with the invention. DeBEE 2000 (BEE International Ltd.) is an example of an emulsification device using such an ultrahigh-pressure jet flow.

Water, organic solvents, or mixed solvents thereof can be used as the aqueous medium in the above-described dispersion process. Examples of the organic solvent that can be used for the dispersion process include alcohols such as methanol, ethanol, n-propanol, i-propanol, and methoxypropanol, ketones such as acetone and methyl ethyl ketone, and also tetrahydrofuran, acetonitrile, ethyl acetate, and toluene.

The cationic polyurethane itself can produce a naturally stable emulsified dispersion, but a small amount of a dispersant (surfactant) may be used together therewith to accelerate the emulsification and dispersion, or to further improve stability. Examples of the surfactant that can be used for this purpose include anionic surfactants such as fatty acid salts, alkylsulfonic acid ester salts, alkylbenzenesulfonates, alkylnaphthalenesulfonates, diakylsulfosuccinates, alkylphosphoric acid ester salts, napthalenesulfonic acid formalin condensate, and polyoxyethylene alkylsulfonic acid ester salts, and nonionic surfactants such as polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkylamines, glycerin fatty acid esters, and oxyethylene oxypropylene block copolymers. Furthermore, Surfynol's (Air Products & Chemical Co., Ltd.), which are acetylene-based polyoxyethylene oxide surfactants, can be also advantageously used. Amineoxide amphoteric surfactants such as N,N-dimethyl-N-alkylamine oxide are also preferred. Compounds described as surfactants in JP-A No. 59-157,636 (pages 37-38) and Research Disclosure No. 308119 (1989) can be also used.

With the object of performing stabilization immediately after emulsification, a water-soluble polymer can be added together with the surfactant. The preferred examples of suitable water-soluble polymers include poly (vinyl alcohol), poly (vinyl pyrrolidone), polyethylene oxide, polyacrylic acid, polyacrylamides, and copolymers thereof. Natural water-soluble polymers such as polysaccharides, casein, and gelatin can be also advantageously used.

When the cationic polyurethane is dispersed in an aqueous dispersion medium by the above-described emulsification dispersion method, it is preferred that the particle size be controlled. Thus, in order to increase color purity and color density when an image is formed by inkjet, it is preferred that an average particle size of the self-emulsifiable polymer in the aqueous dispersion be reduced. More specifically, the volume-average particle size of the cationic polyurethane in the ink-receiving layer in accordance with the invention is preferably equal to or less than 0.05 μm, more preferably equal to or less than 0.04 μm, and even more preferably equal to or less than 0.03 μm.

Aqueous Dispersion of Cation-Modified Self-Emulsifiable Polymer

In the ink-receiving layer in accordance with the invention, it is also possible to use a self-emulsifiable polymer subjected to cation modification (cation-modified self-emulsifiable polymer) other than the above-described cationic polyurethane in addition to the cationic polyurethane.

The “cation-modified self-emulsifiable polymer” means a polymer compound that can make a naturally stable emulsified dispersion in an aqueous dispersion medium, without using an emulsifier or a surfactant, or if used, with addition of a very small amount thereof. Quantitatively, the “cation-modified self-emulsifiable polymer” represents a polymer substance that has a stable emulsification and dispersion ability at a concentration equal to or higher than 0.5% by weight in an aqueous dispersion medium at room temperature of 25° C., and this concentration is preferably equal to or higher than 1% by weight and even more preferably equal to or higher than 3% by weight.

More specifically, the “cation-modified self-emulsifiable polymer” is for example, a polyaddition- or polycondensation-type polymer compound having a cationic group such as a primary to tertiary amino group or a quaternary ammonium group.

Polymers obtained by polymerization of the below-described vinyl monomers are examples of vinyl polymerization-type polymers that are effective as the aforementioned polymers. Examples of the vinyl monomers include acrylic acid esters or methacrylic acid esters (the ester group is of an optionally substituted alkyl group or aryl group, for example, a methyl group, an ethyl group, an n-propyl group, an isopropyl group, an n-butyl group, a sec-butyl group, a tert-butyl group, a hexyl group, a 2-ethylhexyl group, a tert-octyl group, a 2-chloroethyl group, a cyanoethyl group, a 2-acetoxyethyl group, a tetrahydrofurfuryl group, a 5-hydroxypentyl group, a cyclohexyl group, a benzyl group, a hydroxyethyl group, a 3-methoxybutyl group, a 2-(2-methoxyethoxy)ethyl group, a 2,2,2-trifluoroethyl group, a 1,2,2,2-tetrafluoroethyl group, a 1H,1H,2H,2H-perfluorodecyl group, a phenyl group, a 2,4,5-trimethylphenyl group, a 2,3,4,5-tetramethylphenyl group, a 2,4,5,6-tetramethylphenyl group, or a 4-chlorophenyl group);

vinyl esters, more specifically, optionally substituted aliphatic carboxylic acid vinyl esters (for example, vinyl acetate, vinyl propionate, vinyl butyrate, vinyl isobutyrate, vinyl caproate, and vinyl chloroacetate), optionally substituted aromatic carboxylic acid vinyl esters (for example, vinyl benzoate, vinyl 4-methyl benzoate, and vinyl salicylate);

acrylamides, more specifically, acrylamide, N-monosubstituted acrylamide, and N-disubstituted acrylamide (examples of the substituent include an alkyl group, an aryl group, and a silyl group, each of which is optionally substituted, for example, a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-trimethylphenyl group, a 2,3,4,5-tetramethylphenyl group, a 2,4,5,6-tetramethylphenyl group, a 4-chlorophenyl group, and trimethylsilyl);

methacrylamides, more specifically, methacrylamide, N-monosubstituted methacrylamide, and N-disubstituted methacrylamide (examples of the substituent are an alkyl group, an aryl group, and a silyl group, each of which is optionally substituted, for example, a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-trimethylphenyl group, a 2,3,4,5-tetramethylphenyl group, a 2,4,5,6-tetramethylphenyl group, a 4-chlorophenyl group, and a trimethylsilyl group);

olefins (for example, ethylene, propylene, 1-pentene, vinyl chloride, vinylidene chloride, isoprene, chloroprene, and butadiene);

styrenes (for example, styrene, methylstyrene, isopropylstyrene, methoxystyrene, acetoxystyrene, and chlorostyrene); and
vinyl ethers (for example, methyl vinyl ether, butyl vinyl ether, hexyl vinyl ether, and methoxyethyl vinyl ether).

Other examples of vinyl monomers include crotonic acid esters, itaconic acid esters, maleic acid diesters, fumaric acid diesters, methyl vinyl ketone, phenyl vinyl ketone, methoxyethyl vinyl ketone, N-vinyl oxazolidone, N-vinyl pyrrolidone, methylene malononitrile, diphenyl-2-acryloyl oxyethyl phosphate, diphenyl-2-methacryloyl oxyethyl phosphate, dibutyl-2-acryloyl oxyethyl phosphate, and dioctyl-2-methacryloyl oxyethyl phosphate.

Examples of the monomer having a cationic group include monomers having a tertiary amino group, such as dialkylaminoethyl methacrylates or dialkylaminoethyl acrylates.

Examples of the cation-modified self-emulsifiable polymer include polyesters having a cationic group.

Examples of polyesters having a cationic group include polyesters synthesized by a polycondensation reaction between the below-described diol compounds and the below-described dicarboxylic acid compounds in a variety of combination.

Examples of the dicarboxylic acid compounds include oxalic acid, malonic acid, succinic acid, glutalic acid, dimethylmalonic acid, adipic acid, pimelic acid, α,α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethylene terephthalate)dicarboxylic acid, 1,2-cyclohexanedicarboxylic acid, 1,4-cyclohexanedicarboxylic acid, ω-poly(ethylene oxide)dicarboxylic acid, and p-xylylenedicarboxylic acid.

Where the dicarboxylic acid compound and the diol compound are subjected to polycondensation reaction, the dicarboxylic acid compound may be a dicarboxylic acid alkyl ester (for example, a dimethyl ester), or a dicarboxylic acid chloride. Alternatively, the dicarboxylic acid compound may be a dicarboxylic acid anhydride such as malic anhydride, succinic anhydride, or phthalic anhydride.

As for the diol compound, the same compound as those exemplified with respect to the cationic polyurethane may be also used.

The polyester having a cationic group is obtained by synthesis using a dicarboxylic acid compound having a cationic group such as a primary, secondary, tertiary amino group, or a quaternary ammonium salt.

The diol compound, the dicarboxylic acids, and the hydroxycarboxylic acid ester compound that are used as a component of the synthesis of the polyester may be used singly, or alternatively two or more compounds of each of these components may be mixed and used at arbitrary ratios according to the desired object (for example, adjustment of glass transition temperature (Tg), solubility of the polymer, compatibility with a dye, or dispersion stability).

Zirconium Salt

Examples of the zirconium salt used in accordance with the invention include zirconium acetate, zirconium oxyacetate (zirconyl acetate), zirconium chloride, zirconium oxychloride, zirconium hydroxychloride, zirconium nitrate, basic zirconium carbonate, zirconium hydroxide, zirconium lactate, zirconium ammonium carbonate, zirconium potassium carbonate, zirconium sulfate, and zirconium fluoride compounds.

These compounds are marketed by Dai-ichi Kigenso Kagaku Kogyo Co., Ltd. as ZIRCOSOL ZA-20, ZIRCOSOL ZA-30, and ZIRCOSOL ZC-2. They are also marketed by Nippon Light Metal Co., Ltd.

The zirconium salts may be used singly or in combinations of two or more thereof.

When the ink-receiving layer in accordance with the invention includes a zirconium salt, the zirconium salt is preferably added at a proportion of equal to or higher than 1% by weightand less than 30% by weight, and more preferably from 2 to 25% by weight, with respect to inorganic fine particles contained in the ink-receiving layer (for example, the lower layer) including the zirconium salt.

Organic Compound Having Sulfo Group

From the standpoint of further increasing ozone resistance, it is preferred that at least one layer (preferably, the uppermost layer) of the ink-receiving layer in accordance with the invention includes an organic compound having a sulfo group.

The organic compound having a sulfo group is not particularly limited, but a compound with small optical absorption in a visible range is preferred. Furthermore, it is preferred that the organic compound or a salt thereof (sulfonate) be soluble in water at 0.1% by weight or higher.

Specific examples of the organic compound having a sulfo group include methanesulfonic acid, hydroxymethanesulfonic acid, ethanesulfonic acid, 1-propanesulfonic acid, 2-propanesulfonic acid, 1-butanesulfonic acid, 1-pentanesulfonic acid, 1-hexanesulfonic acid, 1-heptanesulfonic acid, 1-octanesulfonic acid, 1-nonanesulfonic acid, 1-decanesulfonic acid, vinylsulfonic acid, 2-methyl-2-propenesulfonic acid, aminomethanesulfonic acid, taurine, 3-amino-1-propanesulfonic acid, sulfoacetic acid, benzenesulfonic acid, 4-ethylbenzenesulfonic acid, 4-chlorobenzenesulfonic acid, p-toluenesulfonic acid, 2-naphthalenesulfonic acid, 1,5-naphthalenedisulfonic acid, trifluoromethanesulfonic acid, styrenesulfonic acid, and hydroxybenzenesulfonic acid. Among them, methanesulfonic acid, ethanesulfonic acid, benzenesulfonic acid, p-toluenesulfonic acid, 2-naphthalenesulfonic acid, and 1,5-naphthalenedisulfonic acid are especially preferred.

From the standpoint of increasing ozone resistance more effectively, it is preferred that the use amount of the organic compound having a sulfo group be from 0.01 g/m² to 1.0 g/m², more preferably from 0.02 g/m² to 0.8 g/m², and even more preferably from 0.03 g/m² to 0.6 g/m².

From a similar standpoint, it is preferred that the content of the organic compound having a sulfo group be from 0.004 to 0.45% by weight, more preferably from 0.008 to 0.36% by weight, and even more preferably from 0.012 to 0.27% by weight relative to the total amount of solids of all the ink-receiving layers.

Furthermore, where the organic compound having a sulfo group is introduced into the ink-receiving layer (that is, the ink-receiving layer in which pseudoboehmite alumina is used as a porosity-providing pigment) in accordance with the invention, it is possible to achieve significant effects on not only increase in ozone resistance, but also inhibition of bleeding due to moisture and heat and increase in print density.

From the standpoint of balancing inhibition of bleeding due to moisture and heat, increase in ozone resistance and increase in print density, a naphthalene ring-containing organic compound (hereinafter, also referred to as “organic compound having a sulfo group and a naphthalene ring”) is preferred among the organic compounds having a sulfo group.

Specifically, among the “organic compound having a sulfo group and a naphthalene ring”, 2-naphthalenesulfonic acid and 1,5-naphtalenedisulfonic acid are especially preferable.

The use amount of the “organic compound having a sulfo group and a naphthalene ring” is preferably from 0.05 g/m² to 0.5 g/m², and more preferably from 0.1 g/m² to 0.2 g/m². When this amount is equal to or more than 0.05 g/m², the effect of inhibiting bleeding due to moisture and heat, increasing ozone resistance, and increasing print density can be achieved more effectively. When this amount is equal to or less than 0.5 g/m², print density can be further increased.

From a similar standpoint, it is preferred that the content of the “organic compound having a sulfo group and a naphthalene ring” be from 0.02 to 0.25% by weight, and more preferably from 0.04 to 0.10% by weight relative to the total amount of solids in all the ink-receiving layers.

Water-Soluble Polyvalent Metal Compound

A water-soluble polyvalent metal compound other than the above-described zirconium salt may be also contained in the ink-receiving layer in accordance with the invention.

When the pseudoboehmite alumina and the inorganic fine particles are dispersed in water, the water-soluble polyvalent metal compound is preferably contained therein.

The water-soluble polyvalent metal compound as referred to herein is a compound of a metal with a valence of 2 or more that is dissolved to a level equal to or higher than 1% by weight in water at 20° C.

Examples of the water-soluble polyvalent metal compound include water-soluble salts of one or more metals selected from aluminum, calcium, barium, manganese, copper, cobalt, nickel, iron, zinc, chromium, magnesium, tungsten, and molybdenum. Examples of specific compounds include aluminum sulfate, aluminum sulfite, aluminum thiosulfate, aluminum polychloride, aluminum nitrate nonahydrate, aluminum chloride hexahydrate, aluminum acetate, aluminum lactate, basic aluminum thioglycolate, calcium acetate, calcium chloride, calcium formate, calcium sulfate, calcium butyrate, barium acetate, barium sulfate, barium phosphate, barium oxalate, barium naphthoresorcine carboxylate, barium butyrate, manganese chloride, manganese acetate, manganese formate dihydrate, manganese ammonium sulfate hexahydrate, cupric chloride, ammonium copper (II) chloride dihydrate, copper sulfate, copper (II) butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, nickel ammonium sulfate hexahydrate, nickel amidosulfate tetrahydrate, nickel sulfamate, nickel 2-ethylhexanoate, iron (II) bromide, iron (II) chloride, iron (III) chloride, iron (II) sulfate, iron (III) sulfate, iron (III) citrate, iron (III) lactate trihydrate, triammonium iron (III) trioxalate trihydrate, zinc bromide, zinc chloride, zinc nitrate hexahydrate, zinc sulfate, zinc acetate, zinc lactate, chromium acetate, chromium sulfate, magnesium acetate, magnesium oxalate, magnesium sulfate, magnesium chloride hexahydrate, magnesium citrate nonahydrate, sodium phosphotungstate, sodium tungsten citrate, 12-tungstophosphoric acid n-hydrate, 12-tungstosilicic acid 26-hydrate, molybdenum chloride, and 12-molybdophosphoric acid n-hydrate. These water-soluble polyvalent metal compounds may be used in combinations of two or more thereof.

Among these water-soluble polyvalent metal compounds, compounds of aluminum or a metal of group 4A of the periodic table of the elements (for example, titanium) are preferred. Water-soluble aluminum compounds are especially preferred. Examples of inorganic salts known as the water-soluble aluminum compounds include aluminum chloride or hydrates thereof, aluminum sulfate or hydrates thereof, and ammonium alum. A basic aluminum polyhydroxide compound, which is an inorganic aluminum-containing cation polymer, is also known and can be advantageously used.

The basic aluminum polyhydroxide compound as referred to herein is a basic water-soluble aluminum polyhydroxide having a main component represented by the following Formula 1, 2, or 3 and stably including a high-molecular polynuclear condensation ion such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ Formula 1.

[Al(OH)₃]AlCl₃ Formula 2.

Alₙ(OH)ₘCl₍₃ₙ₋ₘ₎ 0<m<3n Formula 3.

Examples of these compounds include basic aluminum chloride (ALFINE 83) marketed by Taimei Chemicals Co., Ltd., poly(aluminum chloride) (PAC) by Taki Kagaku Co., Ltd., poly(aluminum hydroxide) (PAHO) as a water treatment agent by Asada Kagaku KK, and PURACHEM WT by Riken Green KK. Such compounds are also produced by other manufacturers with a similar object, and compounds of various grades are presently readily available.

Hardener

The ink-receiving layer (for example, the uppermost layer and/or lower layer) in accordance with the invention may contain a hardener (crosslinking agent) together with the binder.

Specific examples of the hardener include aldehyde compounds such as formaldehyde or glutalaldehyde; ketone compounds such as diacetyl or chloropentanedione; compounds containing a reactive halogen such as bis(2-chloroethylurea), 2-hydroxy-4,6-dichloro-1,3,5-triazine, or compounds described in U.S. Pat. No. 3,288,775; compounds having a reactive olefin such as divinylsulfone or a compound described in U.S. Pat. No. 3,635,718; N-methylol compounds as described in U.S. Pat. No. 2,732,316; isocyanates as described in U.S. Pat. No. 3,103,437; aziridine compounds as described in U.S. Pat. Nos. 3,017,280 and 2,983,611; carbodiimide compounds as described in U.S. Pat. No. 3,100,704; epoxy compounds as described in U.S. Pat. No. 3,091,537; halogen carboxyaldehydes such as mucochloric acid; dioxane derivatives such as dihydroxydioxane; and inorganic hardeners such as chrome alum, zirconium sulfate, boric acid, or borates. These compounds may be used singly or in combinations of two or more thereof. Among them, boric acid and borates are especially preferred.

When the ink-receiving layer in accordance with the invention includes a hardener, the hardener content is preferably from 0.1 to 40% by weight, and more preferably from 0.5 to 30% by weight relative to the binder constituting the ink-receiving layer.

Other Components

The ink-receiving layer in accordance with the invention may also include a silane coupling agent.

Examples of the silane coupling agent are described in JP-A No. 2000-233572, and among them cationic coupling agents are preferably used. The amount of silane coupling agent added is preferably within a range of 0.1 to 10% by weight relative to the inorganic fine particles.

In accordance with the invention, various oil droplets can be introduced into the ink-receiving layer in order to improve the fragility of film. A hydrophobic high-boiling organic solvent (for example, fluid paraffin, dioctyl phthalate, tricresyl phosphate, and silicone oil) having solubility with respect to water at room temperature of equal to or less than 0.01% by weight or polymer particles (for example, particles produced by polymerization of at least one polymerizable monomer such as styrene, butyl acrylate, divinylbenzene, butyl methacrylate, or hydroxyethyl methacrylate) can be used as such oil droplets. The oil droplets can be used preferably in an amount within a range of 10 to 50% by weight relive to the organic binder.

A variety of hitherto-known additives such as a coloring dye, a coloring pigment, a UV absorber, an antioxidant, a pigment dispersant, an antifoaming agent, a leveling agent, a preservative, a fluorescent whitening agent, a viscosity stabilizer, or a pH regulating agent can be also added to the ink-receiving layer. A pH value of the coating liquid of the ink-receiving layer (A) in accordance with the invention is preferably within a range of 3.3 to 6.5, and more preferably within a range of 3.5 to 5.5. A pH value of the coating liquid of the ink-receiving layer (B) in accordance with the invention is preferably within a range of 3.3 to 6.5, and more preferably within a range of 4.0 to 6.0.

Substrate

The preferred substrate for use in accordance with the invention is a substrate that absorbs no water (hereinafter, referred to as “water-proof substrate”), for example, a polyester resin such as polyethylene terephthalate; a diacetate resin; a triacetate resin; an acrylic resin; a polycarbonate resin; a poly(vinyl chloride) resin; a polyimide resin, a plastic resin film such as cellophane or celluloid; a laminate of a paper and a resin film; and a polyolefin resin-coated paper in which polyolefin resin layers are coated on both surfaces of a base paper. The thickness of the water-proof substrate for use in accordance with the invention is ordinarily from 50 to 300 μm, and preferably from 80 to 260 μm.

A polyolefin resin-coated paper substrate (hereinafter, referred to as “a polyolefin resin-coated paper”) that can be advantageously used in accordance with the invention will be described in greater detail below. A moisture content of the polyolefin resin-coated paper for use in accordance with the invention is not particularly limited, but from the standpoint of curling properties, the moisture content is preferably within a range of 5.0 to 9.0%, and more preferably from 6.0 to 9.0%. The moisture content can be measured according to any moisture measuring method. For example, an infrared moisture meter, a bone-dry weight method, a dielectric constant method, and a Karl-Fischer method can be used.

The base paper that constitutes the polyolefin resin-coated paper is not particularly limited and a commodity-type paper can be used, but a smooth base paper is preferably used. Further, a smooth base paper used, for example, in a substrate for photography is more preferred. One pulp or a mixture of two or more pulps selected from a natural pulp, a recycled pulp, a synthetic pulp, or the like can be used as the pulp that constitutes the base paper. Additives such as a sizing agent, a paper durability enhancer, a filler, an antistatic agent, a fluorescent whitening agent, and a dye that are generally used in paper production can be added to the base paper.

Furthermore, the paper surface may be coated with a surface sizing agent, a surface durability enhancer, a fluorescent whitening agent, an antistatic agent, a dye, an anchor agent, or the like.

A thickness of the base paper is not particularly limited, but a paper having a good surface smoothness that is produced by applying pressure thereto and compressing it using calendar, etc. during or after papermaking is preferred. A basis weight of the base paper is preferably from 30 to 250 g/m².

Examples of polyolefin resins used for coating the base paper include homopolymers of olefins such as a low-density polyethylene, a high-density polyethylene, polypropylene, polybutene, or polypentene; copolymers including two or more olefins as a component such as ethylene-propylene copolymers; and mixtures thereof. Polyolefin resins of various densities or melt viscosity indexes (melt indexes) can be used singly or by mixture.

A variety of additives can be appropriately combined and added to the resin of the polyolefin resin-coated paper. Examples of such additives include a white pigment such as titanium oxide, zinc oxide, talc, or calcium carbonate; a fatty acid amide such as stearic acid amide or arachidic acid amide; a fatty acid metal salt such as zinc stearate, calcium stearate, aluminum stearate, or magnesium stearate; an antioxidant such as IRGANOX 1010 or IRGANOX 1076; blue pigments or dyes such as cobalt blue, ultramarine, cecilian blue, or phthalocyanine blue; magenta pigments or dyes such as cobalt violet, fast violet, or manganese violet; a fluorescent whitening agent; and an UV absorber.

The polyolefin resin-coated paper is mainly manufactured by the so-called extrusion coating method whereby a polyolefin resin is cast on a running base paper in a heated and molten state, and both sides of the base paper are coated with the resin. Before coating the resin on the base paper, the base paper is preferably subjected to an activation treatment such as a corona discharge treatment or a flame treatment. An appropriate thickness of the polyolefin resin-coated layer is from 5 to 50 μm.

It is preferable that an undercoating layer is provided on the water-proof substrate at the side of coating the ink-receiving layer that is used in accordance with the invention. This undercoating layer is coated on the surface of the water-proof substrate and dried before the ink-receiving layer is coated. The undercoating layer includes a film-forming water-soluble polymer or polymer latex as a main component. Water soluble polymers such as gelatin, poly(vinyl alcohol), poly(vinyl pyrrolidone), or a water-soluble cellulose are preferable, and gelatin is especially preferred. The application quantity of the water-soluble polymer is preferably from 10 to 500 m g/m², and more preferably from 20 to 300 mg/m². Furthermore, it is preferred that the undercoating layer also includes a surfactant or a hardener. By providing the undercoating layer on the substrate, it is possible to effectively prevent from cracking during coating of the ink-receiving layer and to obtain a uniform coating surface.

Method for Manufacturing Inkjet Recording Medium

A method for manufacturing the above-described inkjet recording medium in accordance with the invention is not particularly limited. For example, the inkjet recording medium of the invention may be manufactured as follows.

Thus a preferable method for manufacturing the inkjet recording medium in accordance with the invention includes a step of forming an ink-receiving layer by coating at least a coating liquid A including inorganic fine particles, a binder, and a cationic polyurethane and/or a zirconium salt, and a coating liquid B including pseudoboehmite alumina, a binder, and a water-soluble high-boiling solvent on a substrate in the order of the coating liquid A and coating liquid B, as viewed from the substrate side, wherein at least one coating liquid for forming the ink-receiving layer includes a basic compound.

When the ink-receiving layer is formed, if necessary, one or more other coating liquids may be coated between the substrate and the coating liquid A, and/or between the coating liquid A and the coating liquid B, in addition to the coating liquid A and the coating liquid B.

The basic compound may be contained in at least one of coating liquids (the coating liquid A, the coating liquid B, and other coating liquids that are used in accordance with necessity) for forming the ink-receiving layer.

From the standpoint of obtaining the effect of the invention more effectively, it is preferred that the basic compound be contained in the coating liquid A and/or the coating liquid B, and more preferably in the coating liquid B.

Components of the above-described lower layer can be used as the inorganic fine particles, binder, and cationic polyurethane and/or zirconium salt and other optional components that are contained in the coating liquid A.

Components of the above-described uppermost layer can be used as the pseudoboehmite alumina, binder, water-soluble high-boiling solvent and other optional components that are contained in the coating liquid B.

Basic compounds and other components of the above-described ink-receiving layers can be used as the basic compound and other optional components that are contained in at least one coating liquid.

In the aforementioned manufacturing method, a method for coating the coating liquid A and the coating liquid B (and other components that are used in accordance with necessity) is not particularly limited, provided that coating is performed in the order of the coating liquid A and coating liquid B, as viewed from the substrate side.

For example, a successive coating method whereby layers are successively and individually coated (for example, with a blade coater, an air knife coater, a roll coater, a bar coater, a gravure coater, or a reverse coater) or a simultaneous multilayer coating method (for example, with a slide bead coater or a slide curtain coater) may be used. Furthermore, for example, a “Wet-On-Wet Method” (hereinafter, referred to as “WOW method”) described in paragraphs from 0016 to 0037 of JP-A No. 2005-14593 may be also used.

Among these methods, a multilayer simultaneous coating method is preferred.

Preparation of Coating Liquid

In the invention, a method for preparing coating liquids (for example, the coating liquid A, coating liquid B, and other coating liquids that are used in accordance with necessity) for forming the ink-receiving layer is not particularly limited, and a known method whereby the components contained in the coating liquids are mixed and stirred can be used.

From the standpoint of obtaining the effect of the invention more effectively, a preferable method for preparing a coating liquid is a technique whereby first, a dispersion of inorganic fine particles (for example, pseudoboehmite alumina dispersion or vapor-phase silica dispersion) is prepared, and then the thus-prepared fine particle dispersion is mixed with other components.

In this case, it is preferred that the fine particle dispersion and other components are each previously maintained at the same temperature and they are mixed at the maintained temperature. A specific temperature of the coating liquid is preferably from 40 to 70° C., and more preferably from 45 to 60° C.

Drying

In accordance with the invention, a coating film (ink-receiving layer) formed by coating a coating liquid (for example, the coating liquid A and coating liquid B) for forming the ink-receiving layer can be dried by a known method.

The drying temperature is preferably within a range of 10 to 100° C., and more preferably from 20 to 80° C., though a preferable temperature changes depending on heat resistance of the substrate.

Furthermore, by performing a heat treatment within a range providing no adverse effect on the substrate after coating and subsequent sufficient drying of the ink-receiving layer, it is possible to increase a pore volume of the ink-receiving layer. As a result, ink absorption ability is improved and water resistance of the ink-receiving layer can be further increased. The heat treatment is preferably performed at a temperature of from 30 to 80° C., and more preferably from 40 to 60° C., although the temperature depends on heat resistance of the substrate.

Preferable Application Method for Organic Compound Having a Sulfo Group

When the ink-receiving layer in accordance with the invention includes the above-described “organic compound having a sulfo group”, an application method for the “organic compound having a sulfo group” to the ink-receiving layer is not particularly limited. However, because the “organic compound having a sulfo group” is anionic in electric charge, from the standpoint of liquid stability, it is preferred that this compound be contained in a third coating liquid and applied separately from the coating liquid A and the coating liquid B.

For example, from the standpoint of liquid stability, it is preferable to use a technique whereby a basic solution C having a pH equal to or higher than 8.0 and including an organic compound having a sulfo group is prepared separately from the coating liquid A and the coating liquid B, and then the basic solution C is provided on the coating liquid B according to a simultaneous multilayer coating method or WOW method.

A pH value of the basic solution C can be appropriately adjusted to 8.0 or a higher value using, for example, ammonia water, ammonium carbonate, sodium hydroxide, calcium hydroxide, and a compound having an amino group (ethylamine, ethanolamine, diethanolamine, polyallylamine, and the like). If necessary, the basic solution C may include other components such as a crosslinking agent and a surfactant.

More specifically, a more preferable method includes steps of forming an ink-receiving layer by forming a coating layer by coating at least the coating liquid A and the coating liquid B on the substrate in the order of the coating liquid A and the coating liquid B as viewed from the substrate side, and by providing the basic solution C on these coating layers either (1) at the same time with coating of the coating liquid B, or (2) during drying of the thus-formed coating layers, but before these coating layers show decreasing drying (the method of (2) is a Wet On Wet method (WOW method)), wherein the basic compound is contained in at least one coating liquid (for example, the coating liquid A, the coating liquid B, or the basic solution C) for forming the ink-receiving layer.

By forming the ink-receiving layer according to this method, it is possible to inhibit aggregation or thickening of the pseudoboehmite alumina dispersion more effectively and form an inkjet recording medium having a very good gloss feel and a high print density.

From the standpoint of further increasing the film strength by crosslinking and hardening, it is preferred that the coating liquid B and/or basic solution C in the above-described method include a crosslinking agent.

The expression “before the coating layer demonstrates decreasing drying” usually refers to an interval of several minutes from immediately after the coating liquid for the ink-receiving layer has been coated. Within this interval, the drying shows a phenomenon of “constant-rate drying” in which the content of a solvent (dispersion medium) in the coated coating layer decreases proportionally to the elapse of time. The time showing the “constant-rate drying” is described, for example, in Kagaku Kogaku Benran (Handbook of Chemical Engineering) (pages 707-712, published by Maruzen, Oct. 25, 1980).

Ink Set

The ink set used in the invention includes a combination of a cyan ink containing a cyan dye including 50% by mass or more of a compound represented by the later-described Formula (C-1) and a magenta ink as a component.

The ink set used in the present invention may also be a combination of other color inks such as a yellow ink or a black ink together with the cyan dye and the magenta dye.

Hereinafter, the ink is also referred to as an “ink composition”.

Cyan Ink

### Cyan Dye

The cyan ink used in the invention includes a cyan dye containing 50% by mass or more of a compound represented by Formula (C-1). By combining the cyan ink used in the present invention and the above-described inkjet recording medium used in the present invention, ozone resistance and light fastness of a recorded image are increased, and bronzing is suppressed.

When the content of the compound represented by Formula (C-1) in the cyan dye is lower than 50% by mass, ozone resistance and light fastness may decrease.

The compound represented by Formula (C-1) in the invention is a dye having a phthalocyanine skeleton as shown below. Hereinafter, the compound represented by Formula (C-1) used in the invention is also referred to as a phthalocyanine dye used in the invention.

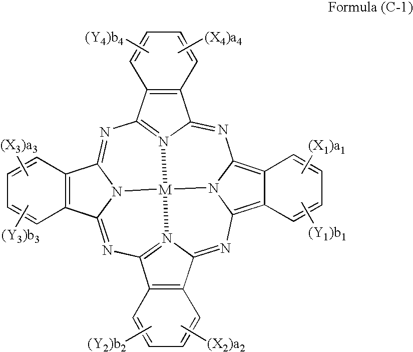

In Formula (C-1), X₁, X₂, X₃, and X₄ each independently represent any of —SO—Z, —SO₂—Z, —SO₂NV₁V₂, —CONV₁V₂, —CO₂Z, —CO—Z, and a sulfo group. In Formula (C-1), Z′s each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. V₁ and V₂ may be the same or different and each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group. Each group may further have a substituent.

a₁ to a₄ and b₁ to b₄ each represent the number of substituents of X₁ to X₄ and Y₁ to Y₄, respectively. a₁ to a₄ each independently represent an integer of from 0 to 4, provided that a₁ to a₄ are not all 0 at the same time. b₁ to b₄ each independently represent an integer of from 0 to 4.

M represents a hydrogen atom, a metal atom, oxides thereof, hydroxides thereof, or halides thereof. Herein, at least one of X₁, X₂, X₃, X₄, Y₁, Y₂, Y₃, or Y₄ must be an ionic hydrophilic group or a group having an ionic hydrophilic group as a substituent.

In the invention, it is preferable that, in Formula (C-1), a₁, a₂, a₃, and a₄ be 0 or 1 and two or more of a₁, a₂, a₃, and a₄ be 1. Furthermore, it is preferable that b₁, b₂, b₃, and b₄ each be an integer such that the total of (b₁, b₂, b₃, and b₄) and (a₁, a₂, a₃, and a₄) gets 4.

As described above, in Formula (C-1), X₁, X₂, X₃ and X₄ each independently represent any of —SO—Z, —SO₂—Z, —SO₂NV₁V₂, —CO₂NV₁V₂, —CO₂Z, —CO—Z, and a sulfo group.

Zs may be the same or different and each represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

A substituted or unsubstituted alkyl group, a substituted or unsubstituted aryl group, or a substituted or unsubstituted heterocyclic group is preferable. Among these groups, a substituted alkyl group, a substituted aryl group, and a substituted heterocyclic group are preferable, and particularly a substituted alkyl group is most preferable.

V₁ and V₂ may be the same or different, and each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. A hydrogen atom, a substituted or unsubstituted alkyl group, a substituted or unsubstituted aryl group, and a substituted or unsubstituted heterocyclic group are preferable. Among these groups, a hydrogen atom, a substituted alkyl group, a substituted aryl group, and a substituted heterocyclic group are most preferable.

Z, V₁, and V₂ each may further have a substituent. Examples of substituents that Z, V₁, and V₂ each independently may have include halogen atoms (e.g., a chlorine atom and a bromine atom); straight or branched alkyl groups having 1 to 12 carbon atoms, aralkyl groups having 7 to 18 carbon atoms, alkenyl groups having 2 to 12 carbon atoms, straight or branched alkynyl groups having 2 to 12 carbon atoms, cycloalkyl groups having 3 to 12 carbon atoms wherein the cycloalkyl group may have a side chain, cycloalkenyl groups having 3 to 12 carbon atoms wherein the cycloalkenyl group may have a side chain (examples of these groups include methyl, ethyl, propyl, isopropyl, t-butyl, 2-methanesulfonyl ethyl, 3-phenoxypropyl, trifluoromethyl, and cyclopentyl); aryl groups (e.g., phenyl, 4-t-butylphenyl, and 2,4-di-t-amyl phenyl); heterocyclic groups (e.g., imidazolyl, pyrazolyl, triazolyl, 2-furyl, 2-thienyl, 2-pyrimidinyl, and 2-benzothiazolyl); alkyloxy groups (e.g., methoxy, ethoxy, 2-methoxyethoxy, and 2-methanesulfonyl ethoxy); aryloxy groups (e.g., phenoxy, 2-methylphenoxy, 4-t-butylphenoxy, 3-nitrophenoxy, 3-t-butyloxy carbamoylphenoxy, and 3-methoxycarbamoyl); acylamino groups (e.g., acetamide, benzamide, and 4-(3-t-butyl-4-hydroxyphenoxy)butaneamide); alkylamino groups (e.g., methylamino, butylamino, diethylamino, and methylbutylamino); anilino groups (e.g., phenylamino and 2-chloroanilino); ureido groups (e.g., phenyl ureido, methyl ureido, and N,N-dibutyl ureido); sulfamoylamino groups (e.g., N,N-dipropylsulfamoylamino); alkylthio groups (e.g., methylthio, octylthio, and 2-phenoxyethylthio); arylthio groups (e.g., phenylthio, 2-butoxy-5-t-octylphenylthio, and 2-carboxyphenylthio); alkyloxy carbonylamino groups (e.g., methoxycarbonylamino); sulfonamide groups (e.g., methanesulfon amide, benzenesulfonamide, p-toluenesulfonamide, and octadecane); carbamoyl groups (e.g., N-ethylcarbamoyl, and N,N-dibutylcarbamoyl); sulfamoyl groups (e.g., N-ethyl sulfamoyl, N,N-dipropyl sulfamoyl, N,N-diethyl sulfamoyl, and 2-hydroxypropyl sulfamoyl); sulfonyl groups (e.g., methanesulfonyl, octanesulfonyl, benzenesulfonyl, and toluenesulfonyl); alkyloxy carbonyl groups (e.g., methoxy carbonyl, and butyloxy carbonyl); heterocyclic oxy groups (e.g., 1-phenyltetrazole-5-oxy, and 2-tetrahydropyranyloxy); azo groups (e.g., phenylazo, 4-methoxy phenylazo, 4-pivaloyl amino phenylazo, and 2-hydroxy-4-propanoyl phenylazo); acyloxy groups (e.g., acetoxy); carbamoyloxy groups (e.g., an N-methylcarbamoyloxy, and N-phenylcarbamoyloxy); silyloxy groups (e.g., trimethylsilyloxy, and dibutylmethyl silyloxy); aryloxycarbonylamino groups (e.g., phenoxycarbonylamino); imido groups (e.g., N-succinimide, and N-phthalimide); heterocyclic thio groups (e.g., 2-benzothiazolylthio, 2,4-di-phenoxy-1,3,5-triazole-6-thio, and 2-pyridylthio); sulfinyl groups (e.g., 3-phenoxypropylsulfinyl); phosphonyl groups (e.g., phenoxy phosphonyl, octyloxy phosphonyl, and phenyl phosphonyl); aryloxy carbonyl groups (e.g., phenoxycarbonyl); acyl groups (e.g., acetyl, 3-phenylpropanoly, and benzoyl); ionic hydrophilic groups (e.g., a carboxyl group, a sulfo group, and a quaternary ammonium group); cyano groups; hydroxy groups; nitro groups; and amino groups.

Hereinafter, the substituents mentioned above are also referred to as “substituents that Formula (C-1) may have”.

As the substituted or unsubstituted alkyl groups represented by Z, V₁, and V₂, alkyl groups having 1 to 30 carbon atoms are preferable. In particular, branched alkyl groups are preferable because both solubility of a dye and ink stability are improved, and particularly alkyl groups having an asymmetric carbon atom (use in the form of a racemic body) are particularly preferable. Examples of a substituent include substituents that Formula (C-1) may have. In particular, a hydroxy group, an ether group, an ester group, a cyano group, an amino group, an amide group, a sulfonamide group, and a sulfamoyl group (e.g., N-ethylsulfamoyl, N,N-dipropylsulfamoyl, N,N-diethylsulfamoyl, and 2-hydroxypropylsulfamoyl) are particularly preferable because association properties of a dye are increased and fastness is improved. In addition, the substituent may include a halogen atom or an ionic hydrophilic group.

As the substituted or unsubstituted cycloalkyl groups represented by Z, V₁, and V₂, cycloalkyl groups having 5 to 30 carbon atoms are preferable. In particular, cycloalkyl groups having an asymmetric carbon atom (use in the form of a racemic body) are particularly preferable because both solubility of a dye and ink stability are improved. Examples of a substituent include the substituents that Formula (C-1) may have. In particular, a hydroxy group, an ether group, an ester group, a cyano group, an amino group, an amide group, and a sulfonamide group are particularly preferable because association properties of a dye are increased and fastness is improved. In addition, the substituent may include a halogen atom or an ionic hydrophilic group.

As the substituted or unsubstituted alkenyl groups represented by Z, V₁, and V₂, alkenyl groups having 2 to 30 carbon atoms are preferable. In particular, branched alkenyl groups are preferable because both solubility of a dye and ink stability are improved, and alkenyl groups having an asymmetric carbon atom (use in the form of a racemic body) are particularly preferable. Examples of a substituent include substituents that Formula (C-1) may have. In particular, a hydroxy group, an ether group, an ester group, a cyano group, an amino group, an amide group, and a sulfonamide group are particularly preferable because association properties of a dye is increased and fastness is improved. In addition, the substituent may include a halogen atom or an ionic hydrophilic group.

As the substituted or unsubstituted alkynyl groups represented by Z, V₁, and V₂, alkynyl groups having 2 to 30 carbon atoms are preferable. In particular, branched alkynyl groups are preferable because both solubility of a dye and ink stability are improved, and particularly alkynyl groups having an asymmetric carbon atom (use in the form of a racemic body) are particularly preferable. Examples of a substituent include substituents that Formula (C-1) may have. In particular, a hydroxy group, an ether group, an ester group, a cyano group, an amino group, an amide group, and a sulfonamide group are particularly preferable because association properties of a dye are increased and fastness is improved. In addition, the substituent may include a halogen atom or an ionic hydrophilic group.

As the substituted or unsubstituted aralkyl groups represented by Z, V₁, and V₂, aralkyl groups having 7 to 30 carbon atoms are preferable. In particular, a branched aralkyl groups are preferable because both solubility of a dye and ink stability are improved, and particularly aralkyl groups having an asymmetric carbon atom (use in the form of a racemic body) are particularly preferable. Examples of a substituent include substituents that Formula (C-1) may have. In particular, a hydroxy group, an ether group, an ester group, a cyano group, an amino group, an amide group, and a sulfonamide group are particularly preferable because association properties of a dye are increased and fastness is improved. In addition, the substituent may include a halogen atom or an ionic hydrophilic group.

As the substituted or unsubstituted aryl groups represented by Z, V₁, and V₂, aryl groups having 6 to 30 carbon atoms are preferable. Examples of a substituent include substituents that may be contained in Formula (C-1). In particular, electron withdrawing groups are preferable because oxidation potential of a dye is made positive and fastness is improved.

The heterocyclic groups represented by Z, V₁ and V₂ each are preferably a 5- or 6-membered ring, which may be further condensed. The 5- or 6-membered ring may be an aromatic heterocyclic group or a non-aromatic heterocyclic group. The heterocyclic groups represented by Z, V₁ and V₂ will be mentioned in the heterocyclic form free of substitution site, but the substitution site is not limited. Pyridine, for example, can be substituted at the 2-position, 3-position or 4-position. Examples of the heterocyclic groups represented by Z, V₁ and V₂ include pyridine, pyrazine, pyrimidine, pyridazine, triazine, quinoline, isoquinoline, quinazoline, cinnoline, phthaladine, quinoxaline, pyrrole, indole, furane, benzofurane, thiophene, benzothiophene, pyrazole, imidazole, benzimidazole, triazole, oxazole, benzoxazole, thiazole, benzothiazole, isothiazole, benzisothiazole, thiadiazole, isooxaole, benziosooxazole, pyrrolidine, piperidine, piperadine, imidazolidine, and thiazoline. Among these groups, aromatic heterocyclic groups are preferable. Preferable examples of the aromatic heterocyclic group recited in the same manner as above include pyridine, pyrazine, pyrimidine, pyridazine, triazine, pyrazole, imidazole, benzimidazole, triazole, thiazole, benzothiazole, isothiazole, benzisothiazole, and thiadiazole. They may have a substituent. Examples of the substituent may include substituents that Formula (C-1) may have. Examples of preferable substituents include the same as those of the aryl group mentioned above, and examples of more preferable substituents include the same as those of the aryl group recited as a more preferable substituent.

It is preferable that the phthalocyanine dye represented by Formula (C-1) of the invention has an ionic hydrophilic group and the phthalocyanine dye is water soluble. Examples of the ionic hydrophilic group include a sulfo group, a carboxyl group, a phosphono group, and a quaternary ammonium. As the ionic hydrophilic group, a carboxyl group, a phosphono group, and a sulfo group are preferable, and particularly a carboxyl group and a sulfo group are preferable. The carboxyl group, the phosphono group, and the sulfo group may be in the form of salt. Examples of a counter ion constituting the salt include ammonium ion, alkaline metal ions (e.g., lithium ion, sodium ion, and potassium ion), and organic cations (e.g., tetramethylammonium ion, tetramethylguanidinium ion, and tetramethylphosphonium). Among these counter ions, alkaline metal salts are preferable. In particular, lithium salts are particularly preferable because they enhance solubility of a dye and increase ink stability. The most preferable ionic hydrophilic group is a lithium salt of a sulfo group.

The number of ionic hydrophilic groups is preferably 2 or more per molecule of the phthalocyanine dye of the invention. In particular, the phthalocyanine dye having at least two of the group consisting of a sulfo group and a carboxyl group is particularly preferable.

Preferable examples of M include a hydrogen atom and a metal atom, such as Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, or Bi. Examples of oxides include VO and GeO. Examples of hydroxides include Si(OH)₂, Cr(OH)₂, and Sn(OH)₂. Examples of halides include AlCl, SiCl₂, VCl, VCl₂, VOCl, FeCl, GaCl, and ZrCl. Among these materials, Cu, Ni, Zn, Al, and the like are preferable, and Cu is most preferable.

With respect to the chemical structure of the phthalocyanine dye of the invention, it is particularly preferable that at least one of the group consisting of a sulfinyl group (—SO—Z), a sulfonyl group (—SO₂—Z), a sulfamoyl group (—SO₂NV₁V₂), a carbamoyl group (—CONV₁V₂), an alkoxycarbonyl group, an aryloxycarbonyl group, a heterocyclic oxycarbonyl group (—CO₂Z), an acyl group (—CO—Z), and a sulfo group be introduced into each benzene ring of the phthalocyanine of the invention so that the total substituent up value of the entire phthalocyanine skeleton is 1.2 or more.

Among these groups, a sulfinyl group (—SO—Z), a sulfonyl group (—SO₂Z), and a sulfamoyl group (—SO₂NV₁V₂) are preferable. Further, a sulfonyl group (—SO₂Z) and a sulfamoyl group (—SO₂NV₁V₂) are more preferable, and a sulfonyl group (—SO₂Z) is most preferable.

The Hammett's substituent constant up value will be briefly explained below. The Hammett's rule is an empirical rule that L. P. Hammett proposed in 1935 to quantitatively discuss the effects of substituents on the reaction or equilibrium of benzene derivatives, and the validity of this empirical rule has been widely accepted today.

Substituent constants determined by the Hammett's rule are σp value and σm value, and these values are found in many general literatures, and for the details of these values, reference can be made to J. A. Dean, “Lange's Handbook of Chemistry”, 12th ed., 1979 (Mc Graw-Hill), and “Kagaku no Ryoiki (Region of Chemistry)”, extra edition, No. 122, pp. 96-103, 1979 (Nankodo).

As a preferable combination of substituents of the compounds represented by Formula (C-1), compounds in which at least one of various substituents is one of the preferable substituents mentioned above are preferable. Further, compounds in which much more various substituents are the preferable substituents mentioned above are more preferable, and compounds in which all the substituents are the preferable substituents mentioned above are most preferable.

In the invention, the compound represented by Formula (C-1) is preferably a compound represented by the following Formula (C-2) or a salt thereof.

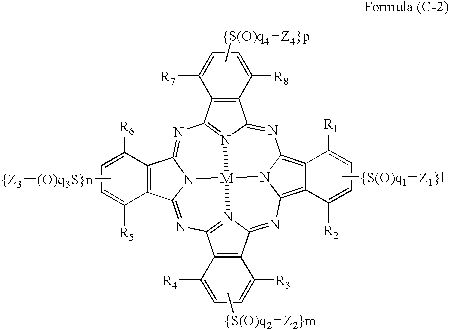

In Formula (C-2), R₁, R₂, R₃, R₄, R₅, R₆, R₇, and R₈ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryl oxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group. These groups may further have a substituent.

Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. At least one of Z₁, Z₂, Z₃, or Z₄ has an ionic hydrophilic group as a substituent.

In Formula (C-2), m, n, p, q₁, q₂, q₃, and q₄ each independently represent an integer of 1 or 2.

M is the same as M in Formula (C-1).

In the invention, l, m, n, and p in Formula (C-2) each independently represent an integer of 1 or 2. In particular, it is preferable that two or more of l, m, n, and p be 1, and 1=m=n=p=1 is most preferable.

In Formula (C-2) above, q₁, q₂, q₃, and q₄ each independently represent an integer of 1 or 2. In particular, it is preferable that two or more of q₁, q₂, q₃, and q₄ be 2, and q₁=q₂=q₃=q₄=2 is most preferable.

In Formula (C-2), Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, and a substituted or unsubstituted alkyl group, a substituted or unsubstituted aryl group, and a substituted or unsubstituted heterocyclic group are preferable. Among these groups, a substituted alkyl group, a substituted aryl group, and a substituted heterocyclic group are preferable, and particularly a substituted alkyl group is most preferable. At least one of Z₁, Z₂, Z₃, or Z₄ has an ionic hydrophilic group as a substituent.

In Formula (C-2), R₁, R₂, R₃, R₄, R₅, R₆, R₇, and R₈ each preferably represent a hydrogen atom, a halogen atom, an alkyl group, an aryl group, a heterocyclic group, a cyano group, a hydroxyl group, a nitro group, a carbamoyl group, a sulfamoyl group, an alkoxycarbonyl group, an aryloxy carbonyl group, a phosphoryl group, an acyl group, or an ionic hydrophilic group, more preferably a hydrogen atom, a halogen atom, a cyano group, a hydroxyl group, a sulfamoyl group, or an ionic hydrophilic group, and particularly most preferably a hydrogen atom.

In Formula (C-2), M is the same as M in Formula (C-1), and preferable examples are also the same.

As a preferable combination of substituents of the compound represented by Formula (C-2), compounds in which at least one of various substituents is one of the preferable substituents mentioned above are preferable, compounds in which much more various substituents are the preferable substituents mentioned above are more preferable, and compounds in which all the substituents are the preferable substituents mentioned above are most preferable.

The compound represented by Formula (C-2) in the invention is preferably a compound represented by Formula (C-3) and a salt thereof.

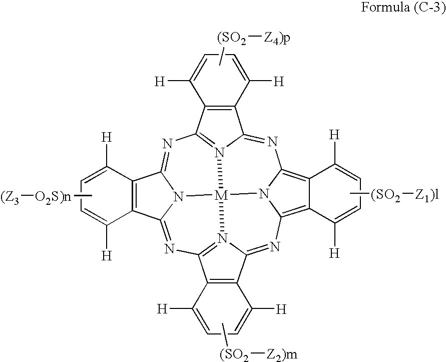

In Formula (C-3), Z₁, Z₂, Z₃, Z₄, l, m, n, p, and M are the same as Z₁, Z₂, Z₃, Z₄, l, m, n, p, and M, respectively in Formula (C-2).

In the invention, in Formula (C-3), l, m, n, and p each independently represent an integer of 1 or 2. In particular, it is preferable that two or more of l, m, n, and p be 1 and 1=m=n=p=1 is most preferable.

In Formula (C-3), Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, and preferably a substituted or unsubstituted alkyl group, a substituted or unsubstituted aryl group, or a substituted or unsubstituted heterocyclic group. Among these groups, a substituted alkyl group, a substituted aryl group, and a substituted heterocyclic group are preferable, and particularly a substituted alkyl group is most preferable.

In more detail, Z₁, Z₂, Z₃, and Z₄ each independently represent Z₁₁ (where Z₁₁ represents —(CH₂)₃SO₃M₂ wherein M₂ represents an alkali metal atom) or Z₁₂ (where Z₁₂ represents —(CH₂)₃SO₂NHCH₂CH(OH)CH₃). In particular, a dye mixture in which the molar ratio of Z₁₁ to Z₁₂ (Z₁₁/Z₁₂) included in the entire cyan dye represented by Formula (C-3) above is 4/0, 3/1, 2/2, or 1/3 is preferable. Among these mixtures, a dye mixture having as a main component a dye in which a molar ratio of Z₁₁/Z₁₂ is 3/1, and a dye mixture having as a main component a dye in which a molar ratio of Z₁₁/Z₁₂ is 2/2 are most preferable. At least one of Z₁, Z₂, Z₃, or Z₄ has an ionic hydrophilic group as a substituent.

In —(CH₂)₃SO₃M₂ represented by Z₁₁, M₂ is preferably an alkali metal atom. In particular, a lithium ion, a sodium ion, or a potassium ion is preferable and particularly a lithium ion is most preferable.

In Formula (C-3), M is the same as M in Formula (C-2) and preferable examples are also the same.

As a preferable combination of substituents of the compounds represented by Formula (C-3), compounds in which at least one of various substituents is one of the preferable substituents mentioned above are preferable, compounds in which much more various substituents are the preferable substituents mentioned above are more preferable, and compounds in which all the substituents are the preferable substituents mentioned above are most preferable.

In the invention, the content of a cyan dye contained in a cyan ink composition is determined depending on the type of X₁ to X₄ and Y₁ to Y₄ in Formula (C-1), the type of a solvent component and the like to be used for producing the ink composition. In the invention, the cyan dye represented by Formula (C-1) (dye of Formula (C-1)) are contained in the cyan ink composition in a proportion of preferably from 1 to 10% by mass and more preferably from 2 to 6% by mass in total based on the total amount of the cyan ink composition.

By adjusting the total amount of the dyes of Formula (C-1) contained in the cyan ink composition so as to be 1% by mass or more, favorable color development properties of ink on a recording medium when printed can be achieved and a required image density can be secured. By adjusting the total amount of the dyes of Formula (C-1) contained in the cyan ink composition so as to be 10% by mass or lower, it is possible to obtain, when used for an inkjet recording method, such advantages that favorable ejection properties of the cyan ink composition are achieved, and also clogging of an inkjet nozzle is prohibited.

The ink set of the invention can contain one pair of a cyan ink composition having a relatively high color density (dark cyan ink composition) and a cyan ink composition having a relatively low color density (light cyan ink composition) as a cyan ink composition.

When the dark cyan ink composition and the light cyan ink composition are incorporated in the ink set of the invention, it is preferable for at least one of the dark cyan ink composition and the light cyan ink composition to contain, as a colorant, at least one of the dyes of Formulae (C-1), (C-2), and (C-3) above.

Among the two kinds of cyan ink compositions having different color densities, the light cyan ink composition is preferably a mixture including at least one dye selected from the group consisting of a compound represented by Formula (C-2) and a salt thereof, in which Z₁, Z₂, Z₃, and Z₄ are each independently Z₁₁ (where Z₁₁ represents —(CH₂)₃SO₃M₂, where M₂ represents an alkali metal atom) or Z₁₂ (where Z₁₂ represents —(CH₂)₃SO₂NHCH₂CH(OH)CH₃). In particular, a dye mixture in which the molar ratio of Z₁₁ to Z₁₂ included in the entire cyan dye represented by Formula (C-3) is 4/0, 3/1, 2/2 or 1/3 is preferable. Among the above, a dye mixture having as a main component a dye in which a molar ratio of Z₁₁ to Z₁₂ is 2/2 is most preferable.

In addition, it is also preferable for the light cyan ink composition among the two kinds of the cyan ink compositions having different color densities to contain at least one compound selected from the group consisting of a compound represented by Formula (C-4) and a salt thereof

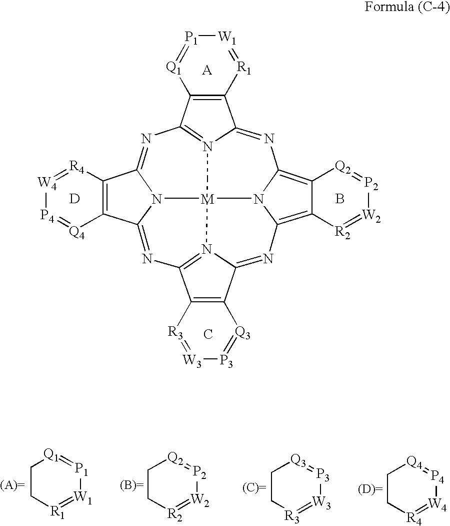

In Formula (C-4), Q₁ to Q₄, P₁ to P₄, W₁ to W₄, and R₁ to R₄ each independently represent (═COO— and/or —N═), (═C(J₂)- and/or —N═), (═C(J₃) and/or —N═), or (═C(J₄)- and/or —N═). J₁ to J₄ each independently represent a hydrogen atom and/or a substituent. At least one of four rings of {A ring: (A), B ring: (B), C ring: (C), D ring: (D)} constituted by (Q₁, P₁, W₁, and R₁), (Q₂, P₂, W₂, R₂), (Q₃, P₃, W₃, R₃), and (Q₄, P₄, W₄, R₄) is a heterocyclic ring.

In more detail, in the cyan dye represented by Formula (C-4), among the four rings of {A ring: (A), B ring: (B), C ring: (C), D ring: (D)} constituted by (Q₁, P₁, W₁, and R₁), (Q₂, P₂, W₂, R₂), (Q₃, P₃, W₃, R₃), and (Q₄, P₄, W₄, R₄), at least one heterocyclic ring is preferably a nitrogen-containing heterocyclic ring. In particular, the heterocyclic ring is preferably a pyridine ring, a pyrazine ring, a pyrimidine ring, or a pyridazine ring, more preferably a pyridine ring or a pyrazine ring, and particularly most preferably a pyridine ring.

More preferably, in the cyan dye represented by Formula (C-4), when the four rings of {A ring: (A), B ring: (B), C ring: (C), D ring: (D)} constituted by (Q₁, P₁, W₁, and R₁), (Q₂, P₂, W₂, R₂), (Q₃, P₃, W₃, R₃), and (Q₄, P₄, W₄, R₄) represent aromatic rings, the aromatic ring represented by Formula (I) is preferable.

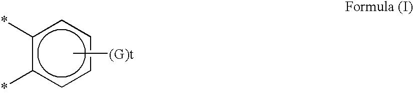

In Formula (I), * represents a connecting position with a phthalocyanine skeleton. In Formula (I), G represents —SO—Z₁, —SO₂—Z₁, —SO₂NZ₂Z₃, —CONZ₂Z₃, —CO₂Z₁, —COZ₁, or a sulfo group. In Formula (I), t represents an integer of 1 to 4.

Z₁s may be the same or different and represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

In Formula (I), examples of preferable Z₁ include a substituted or unsubstituted alkyl group, a substituted or unsubstituted aryl group, and a substituted or unsubstituted heterocyclic group. Among the above, a substituted alkyl group and a substituted aryl group are preferable and particularly an alkyl group is most preferable.

Z₂ and Z₃ may be the same or different, and represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

In Formula (I), examples of preferable Z₂ and Z₃ each independently represent a hydrogen atom, a substituted or unsubstituted alkyl group, a substituted or unsubstituted aryl group, and a substituted or unsubstituted heterocyclic group. Among the above, a hydrogen atom, a substituted alkyl group, and a substituted aryl group are preferable. In particular, it is most preferable that one of Z₂ and Z₃ represents a hydrogen atom and another one represents a substituted alkyl group or a substituted aryl group.

In Formula (I), examples of preferable G include —SO—Z₁, —SO₂—Z₁, —SO₂NZ₂Z₃, —CONZ₂Z₃, —CO₂Z₁, and —COZ₁. Among these groups, —SO—Z₁, —SO₂—Z₁, and —SO₂NZ₂Z₃ are preferable, and particularly —SO₂—Z₁ is most preferable.

In Formula (I), t preferably represents an integer of 1 to 3, and more preferably an integer of 1 to 2, and t=1 is most preferable.

In more detail, when any of the A ring, B ring, C ring, and D ring is an aromatic ring in the cyan dye represented by Formula (C-4), it is preferable that at least one aromatic ring be represented by Formula (II).

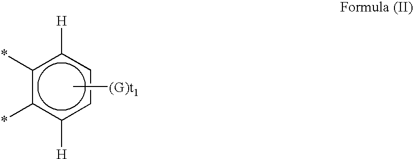

In Formula (II), * represents a connecting position with a phthalocyanine skeleton.

In Formula (II), G is the same as G in Formula (I), and preferable examples are also the same as those of G in Formula (I).

In Formula (II), t₁ is 1 or 2 and particularly t₁=1 is preferable.

Examples of other components that may be contained in the cyan dye in the invention include phthalocyanine dyes other than the compounds represented by Formula (C-1) (e.g., phthalocyanine dyes other than the compounds represented by Formula (C-1) among associative phthalocyanine dyes described in International Application Publication Nos. WO 2002/60994, WO 2003/811, and WO 2003/62324, JP-A Nos. 2003-213167, 2004-75986, 2004-323605, 2004-315758, 2004-315807, and 2005-179469); aryl or heteryl azo dyes having, for example, phenols, naphthols, or anilines, as a coupler component; azomethine dyes having, for example, phenols, naphthols, or heterocyclic rings, such as pyrrolotriazole, as a coupler component; polymethine dyes, such as a cyanine dye, an oxonol dye, or a merocyanine dye; carbonium dyes, such as a diphenylmethane dye, a triphenylmethane dye, or a xanthene dye; anthraquinone dyes; and indigo.thioindigo dyes.

Organic Solvent

It is preferable for the cyan ink in the invention to contain an organic solvent. The cyan ink in the invention can be prepared by dissolving the cyan dye described above in the organic solvent.

There are no restrictions on the organic solvent, and known water soluble organic solvents can be used.

Examples of known water soluble organic solvents include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerol, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, a dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethyl propylenediamine), and other polar solvents (e.g., formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). The water soluble organic solvents may be used in combination of two or more thereof.

It is preferable for the cyan ink in the invention to contain 1 to 60% by mass (total amount) of the water soluble organic solvents described above in terms of prevention of dryness of ink or permeability of ink in image receiving paper. The content (total amount) of the water soluble organic solvent is more preferably 10 to 50% by mass and particularly preferably 15 to 40% by mass.

Other Additives

The cyan ink described above may contain other additives as required.

As other additives, known additives can be used. Examples of other additives include known additives, such as dry inhibitors (wetting agents), fading inhibitors, emulsion stabilizers, penetration accelerators, UV absorbers, antiseptic agents, antifungal agents, pH adjustors, surface tension adjusters, defoaming agents, viscosity controlling agents, dispersing agents, dispersion stabilizers, antirust agents, and chelating agents. These various additives are directly added to ink liquid.

The dry inhibitor is suitably used for the purpose of preventing clogging caused by dryness of ink in an ink ejection opening of a nozzle for use in an inkjet recording method.

As the dry inhibitors, water soluble organic solvents having a vapor pressure lower than that of water are preferable. Specific examples of the dry inhibitor include polyhydric alcohols, such as ethylene glycol, propylene glycol, diethylene glycol, polyethylene glycol, thiodiglycol, dithio diglycol, 2-methyl-1,3-propanediol, 1,2,6-hexanetriol, acetylene glycol derivatives, glycerol, or trimethylolpropane; lower alkyl ethers of polyhydric alcohols, such as ethylene glycol monomethyl (or ethyl)ether, diethylene glycol monomethyl (or ethyl)ether, or triethylene glycol monoethyl (or butyl)ether; heterocycles, such as 2-pyrrolidone, N-methyl-2-pyrrolidone, 1,3-dimethyl-2-imidazolidinone, or N-ethylmorpholine; sulphur-containing compounds, such as sulfolane, dimethyl sulfoxide, or 3-sulfolene; polyfunctional compounds, such as diacetone alcohol or diethanolamine; and urea derivatives. Among these compounds, polyhydric alcohols, such as glycerol or diethylene glycol, are more preferable. The dry inhibitors mentioned above may be used singly or in combination of two or more thereof. It is preferable that the dry inhibitor be contained in ink in a proportion of 10 to 50% by mass.

The penetration accelerator is suitably used for the purpose of penetrating more effectively inkjet ink into a paper. Examples of the penetration accelerator include alcohols, such as ethanol, isopropanol, butanol, di(tri) ethylene glycol monobutyl ether, or 1,2-hexanediol and nonionic surfactants, such as sodium lauryl sulfate or sodium oleate. The penetration accelerators generally exhibit sufficient effects when contained in ink in a proportion of 5 to 30% by mass. It is preferable to use the penetration accelerator with such an addition amount that neither printing blur nor print through. is caused.

The UV absorbers are used for the purpose of improving storability of images. Examples of the UV absorber include benzotriazole compounds mentioned in JP-A Nos. 58-185677, 61-190537, 2-782, 5-197075, and 9-34057, benzophenone compounds mentioned in JP-A Nos. 46-2784 and 5-194483 and U.S. Pat. No. 3,214,463, cinnamic acid compounds mentioned in JP-B Nos. 48-30492, 56-21141, and JP-A No 10-88106, triazine compounds mentioned in JP-A Nos. 4-298503, 8-53427, 8-239368, and 10-182621 and Japanese Application National phase Publication No. 8-501291, compounds mentioned in Research Disclosure No. 24239, and compounds, which absorb ultraviolet rays to produce fluorescence, typified by stilbene or benzoxazole compounds, i.e., a so-called fluorescent brightening agent.

The fading inhibitors are used for the purpose of increasing storability of images. Examples of the fading inhibitors include various organic fading inhibitors and metal complex fading inhibitors. Examples of the organic fading inhibitor include hydroquinones, alkoxy phenols, dialkoxy phenols, phenols, anilines, amines, indans, chromans, alkoxy anilines, and heterocycles. Examples of the metal complex fading inhibitor include nickel complexes and zinc complexes. More specifically, examples include compounds mentioned in patents cited in Research Disclosure Nos. 17643, VII-I or J, 15162, 18716, p. 650, left column, 36544, p. 527, 307105 p. 872, and 15162 or typically exemplified compounds and compounds represented by Formulae mentioned in JP-A No. 62-215272, pp. 127 to 137.

Examples of the antifungal agents include sodium dehydroacetate, sodium benzoate, sodium pyridinethione-1-oxide, ethyl-p-hydroxybenzoate ester, 1,2-benzisothiazoline-3-one, and salts thereof. It is preferable that the antifungal agents be contained in ink in a proportion of 0.02 to 1.00% by mass.

Examples of the pH adjustors include neutralizers (organic bases and inorganic alkalis). The pH adjustors are added for the purpose of increasing storage stability of inkjet ink so that the pH of the inkjet ink is preferably 6 to 10 and more preferably 7 to 10.

Examples of the surface tension adjustors include nonionic surfactants, cationic surfactants, and anionic surfactants. The surface tension of the inkjet ink in the invention is preferably from 25 to 70 mN/m, and more preferably from 25 to 60 mN/m. The viscosity of the inkjet ink in the invention is adjusted to preferably 30 mPa·s or less, and more preferably 20 mPa·s or less. Preferable examples of the surfactant include anionic surfactants, such as fatty acid salts, alkyl sulfate salts, alkylbenzene sulfonic acid salts, alkylnaphthalenesulfonic acid salts, dialkyl sulfosuccinic acid salts, alkyl phosphate salts, naphthalenesulfonic acid formalin condensates, or polyoxyethylene alkyl sulfate salts and nonionic surfactants, such as polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkylamines, glycerol fatty acid esters, or oxyethylene oxypropylene block copolymers. Moreover, various types of Surfynol (product of Air Products & Chemicals) that are acetylene polyoxy ethylene oxide surfactants are also preferably used. Moreover, amine oxide amphoteric surfactants, such as N,N-dimethyl-N-alkylamine oxide, are preferable. The substances mentioned as surfactants in JP-A No. 59-157,636, pp. 37 to 38 and Research Disclosure No. 308119 (1989) can also be used.

As the defoaming agents, chelating agents typified by fluorine compounds, silicone compounds, or EDTA can also be used as required.

The water-based medium contains water as a main component and contains a water soluble organic solvent (hereinafter also referred to as a water-miscible organic solvent). The water soluble organic solvent contains the specific water soluble organic solvents mentioned above.

Here, examples of the water-miscible organic solvents include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerol, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethyl propylenediamine), and other polar solvents (e.g., formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). The water-miscible organic solvents may be used in combination of two or more thereof.

As the content of the water soluble dye in the inkjet recording ink in the invention, each water soluble dye in the invention is contained in the inkjet recording ink in a proportion of preferably from 0.1 part by mass to 20 parts by mass based on 100 parts by mass of the inkjet recording ink.

Each ink of yellow, magenta, cyan, and black inks in the invention may contain two or more kinds of dyes in combination. In such a case, it is preferable that the oxidation potential of 50% or more of the dyes in each ink be more positive than 1.0 V.

In particular, black dyes are difficult to exhibit a preferable black tone with one dye, and thus it is preferable to mix two or more kinds of dyes. It is preferable that the oxidation potential of each dye to be used in such a case be more positive than 1.0 V. When two or more kinds of dyes are used in combination, it is preferable that the total content of the dyes be in the range mentioned above.

In the invention, it is preferable that the magenta ink includes two or more inks having the same hue and a different dye concentration from each other and/or the cyan ink includes two or more inks having the same hue and a different dye concentration from each other in terms of increasing the quality of an image to be obtained.

In the invention, the oxidation potential of dye(s) to be used in each ink of dark and light inks is more positive than preferably 1.0 V, more preferably more positive than 1.1 V, and particularly preferably more positive than 1.15 V.

In the invention, when two or more kinds of different inks are used as inks having the same hue, it is preferable that the ink density of other inks be 0.05 to 0.5 times that of one ink.

In addition, for controlling ink properties, polyethyleneimine, polyamines, polyvinyl pyrrolidone, polyethylene glycol, cellulose derivatives, such as ethyl cellulose or carboxyethyl cellulose, polysaccharides and derivatives thereof, other water-soluble polymers or polymer emulsions, cyclodextrin, macrocyclic amines, dendrimers, crown ethers, urea and derivatives thereof, acetamide, and the like can be used.

Examples of the chelating agent include ethylene diamine tetraacetic acid (EDTA), iminodiacetic acid (IDA), ethylenediamine-di (o-hydroxyphenyl acetic acid) (EDDHA), nitrilotriacetic acid (NTA), dihydroxyethyl glycine (DHEG), trans-1,2-cyclohexanediaminetetraacetic acid (CyDTA), diethylenetriamine-N,N,N′,N′,N′-pentaacetic acid (DTPA), and glycol ether diamine-N,N,N′,N′-tetraacetic acid (GEDTA).

Examples of the viscosity controlling agent include methylcellulose, ethyl cellulose and derivatives thereof, glycerols or polyglycerols and polyethylene oxides or polypropylene oxide adducts thereof, and polysaccharides and derivatives thereof. Specific examples thereof include glucose, fructose, mannite, D-sorbite, dextran, xanthan gum, curdlan, cycloamylose, maltitol, and derivatives thereof.

It is preferable for the ink set for use in the inkjet recording method of the invention to contain a betaine compound as required in each color ink composition. In particular, betaine surfactants having an oil-soluble group are preferable. Among betaine compounds, compounds represented by the below-described Formula (W-1) are preferably used in the invention.

The betaine compounds preferably used in the invention are betaine surfactants having surface activity.

The betaine compound mentioned herein refers to a compound having both a cationic portion and an anionic portion in the molecule.

Examples of the cationic portion include an amine nitrogen atom, a nitrogen atom of a hetero aromatic ring, a boron atom having four bonds with carbon atoms, and a phosphorus atom. Among these atoms, an amine nitrogen atom or a nitrogen atom of a hetero aromatic ring is preferable. In particular, a quaternary nitrogen atom is preferable.

Examples of the anionic portion include a hydroxy group, a thio group, a sulfonamide group, a sulfo group, a carboxyl group, an imido group, a phosphoric acid group, and a phosphonic acid group. Among these groups, a carboxyl group and a sulfo group are particularly preferable. The electric charge of the entire molecule may be cationic, anionic, or neutral and is preferably neutral.

As the betaine compounds, compounds represented by Formula (W-1) are preferably used.

(R)ₚ—N-[L-(COOM)_{q}],ᵣ Formula (W-1)

In Formula (W-1), R represents a hydrogen atom, an alkyl group, an aryl group, or a heterocyclic group. L represents a divalent linking group. M represents a hydrogen atom, an alkali metal atom, an ammonium group, a protonated organic amine or a nitrogen containing heterocyclic group, or a quaternary ammonium ion group. When M is a counter ion of an ammonium ion containing the N atom in Formula (W-1), M represents a group that is not present as a cation. In Formula (W-1), q represents an integer of 1 or more and r represents an integer of from 1 to 4. In Formula (W-1), p represents an integer of 0 to 4 and p+r is equal to 3 or 4. When p+r is equal to 4, the N atom is a protonated ammonium atom (═N⁺═). When q is 2 or more, COOM may be the same or different. When r is 2 or more, L-(COOM)_{q} may be the same or different. When p is 2 or more, Rs may be the same or different.

Preferable specific examples of the betaine compounds include compounds mentioned in JP-A No. 2007-138124, paragraphs [0810] to [0822].

A preferable addition amount of the betaine compounds is not limited insofar as the effects of the invention are shown, and is preferably from 0.001 to 50% by mass and more preferably from 0.01 to 20% by mass relative to an ink composition.

The cyan ink may contain a colorless water-soluble planar compound having ten or more delocalized π electrons in a single molecule as a bronze improving agent. Preferable specific examples of the bronze improving agent include compounds mentioned in JP-A No. 2005-105261, paragraphs [0017] to [0025] or compounds mentioned in JP-A No. 2006-249275, paragraph [0032].

A preferable addition amount of the bronze improving agent is not limited insofar as the effects of the invention are shown, and is preferably from 0.001 to 50% by mass and more preferably from 0.01 to 20% by mass relative to an ink composition.

In order to prevent blur between colors, a pH buffering agent may be blended in the cyan ink. Any substance may be used as a pH buffering agent insofar as the substance is able to stably maintain the pH of ink at 7.0 to 9.5. When the pH of ink is lower than 7.0, blur between colors and uneven coloring are likely to occur and image fixability deteriorates. When the pH of ink exceeds 9.5, components of a head may be damaged. Preferable examples of the pH buffering agent include potassium dihydrogenphosphate/sodium hydroxide, sodium tetraborate/hydrochloric acid, potassium dihydrogen phosphate/disodium hydrogen phosphate, ammonium chloride/ammonia, tris aminomethane/hydrochloric acid, and a combination of a good buffer, such as ACES, ADA, BES, Bicine, Bis-Tris, CHES, DISPO, EPPS, HEPES, HEPPSO, MES, MOPS, MOPSO, POPSO, TAPS, TAPSO, TES, or Tricine and sodium hydroxide, potassium hydroxide, or ammonia. Among these materials, pH buffering agents using sodium hydroxide, potassium hydroxide, or ammonia as an alkali are particularly preferable. The effects of these pH buffering agents are particularly conspicuous when the amount of ink drops is from 1 to 20 p l, and preferably from 2 to 18 p l. The effects are favorably shown in a thermal inkjet system.

The surface tension of the cyan ink is preferably 20 to 70 mN/m and more preferably 25 to 60 mN/m at 20° C. When the surface tension is lower than 20 mN/m, blur on paper becomes remarkable and stable ejection is hard to achieve. Moreover, when the surface tension is larger than 70 mN/m, a sufficient ink penetration into a paper does not occur and color development of secondary colors, such as blue, red, or green, deteriorates, resulting in an unfavorable tendency. It is more effective that the surface tension of black ink at 20° C. is lower than the surface tension of any cyan ink.

The viscosity of the cyan ink is preferably 30 mPa·s or less and more preferably 1.5 to 20 mPa·s at 20° C., and, in such a case, the most favorable results are obtained. When the viscosity is less than 1.5 mPa·s, it is hard to achieve ejection stability. When the viscosity is higher than 20 mPa·s, clogging is likely to occur, resulting in unfavorable tendency.

Magenta Ink

The ink set in the invention has a magenta ink.

By a combination of the magenta ink with the previously above-described inkjet recording medium in the invention, image blur is suppressed.

The magenta ink is not limited, and known magenta inks can be used. For example, magenta inks having magenta dyes are preferable.

As the magenta dyes, water-soluble magenta dyes are preferable. Examples of the magenta dye include aryl or heteryl azo dyes containing phenols, naphthols, anilines, etc., as a coupler component; azomethine dyes containing pyrazolones, pyrazolotriazoles, etc., as a coupler component; methine dyes, such as arylidene dyes, styryl dyes, merocyanine dyes, cyanine dyes, or oxonol dyes; and condensed polycyclic dyes, such as: carbonium dyes, such as diphenylmethane dyes, triphenylmethane dyes, or xanthene dyes, quinone dyes, such as naphthoquinone, anthraquinone, or anthrapyridone, or dioxazine dyes. However, the magenta dye used in the invention is not limited to these compounds.

As the magenta dyes, heterocyclic azo dyes are preferable, and examples of the heterocyclic azo dye include dyes mentioned on pages 35 to 55 of International Patent Publication Nos. WO 2002/83795 and pages 27 to 42 of WO 2002-83662 and paragraphs [0046] to [0059] of JP-A No. 2004-149560, and paragraphs [0047] to [0060] of JP-A No. 2004-149561.

The magenta inks may contain organic solvents and other additives.

The water soluble organic solvents and other additives that can be used for the magenta inks are the same as the above-described organic solvents and other additives for the cyan ink. Preferable ranges of the organic solvents and other additives are the same as those in the cyan ink.

Yellow Ink

The ink set in the invention may have yellow ink.

The yellow ink is not limited, and known yellow inks can be used. For example, yellow inks having yellow dyes are preferable.

As the yellow dyes, water-soluble yellow dyes are preferable. Examples of the yellow dye include yellow dyes mentioned in International Patent Publication No. WO2005/075573, JP-A Nos. 2004-83903 (paragraphs [0024] to [0062]), 2003-277661 (paragraphs [0021] to [0050]), 2003-277262 (paragraphs [0042] to [0047]), 2003-128953 (paragraphs [0025] to [0076]), and 2003-41160 (paragraphs [0028] to [0064]), and U.S. Patent Application Publication No. 2003/0213405 (paragraph [0108]), C.I. direct yellow 8, 9, 11, 12, 27, 28, 29, 33, 35, 39, 41, 44, 50, 53, 59, 68, 86, 87, 93, 95, 96, 98, 100, 106, 108, 109, 110, 130, 132, 142, 144, 161, and 163, C.I. acid yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227, C.I. reactive yellow 2, 3, 13, 14, 15, 17, 18, 23, 24, 25, 26, 27, 29, 35, 37, 41, and 42, and C.I. basic yellow 1, 2, 4, 11, 13, 14, 15, 19, 21, 23, 24, 25, 28, 29, 32, 36, 39, and 40. Moreover, yellow dyes mentioned in JP-A No. 2007-191650, paragraphs [0013] to [0112] and [114] to [0121] are preferable.

The yellow inks may contain organic solvents and other additives.

The organic solvents and other additives that can be used for the yellow inks are the same as the above-described organic solvents and other additives for the cyan ink. Preferable ranges of the organic solvents and other additives are the same as those in the cyan ink.

Black Ink

The ink set in the invention may have black ink.

The black ink is not limited, and known black inks can be used. For example, black inks having black dyes are preferable.

Examples of the black dyes include disazo, trisazo, and tetraazo dyes. These black dyes may be used in combination with a pigment, such as carbon black dispersion.

Preferable examples of the black dyes are described in detail in JP-A No. 2005-307177.

The black inks may contain organic solvents and other additives.

The organic solvents and other additives that can be used for the black inks are the same as the organic solvents and other additives described for the cyan ink above. Preferable ranges of the organic solvents and other additives are the same as those in the cyan ink.

Inkjet System

The inkjet recording method of the invention includes recording an image using the ink set previously described above by an inkjet system on the at least two ink receiving layers of the inkjet recording medium previously described above. The inkjet recording method of the invention may have other processes, such as a drying process, as required.

Hereinafter, recording of an image by the inkjet system is also referred to simply as an “inkjet recording”.

There is no limitation on the inkjet system that can be used for the inkjet recording method of the invention, and known inkjet systems can be used.

Examples of the inkjet system include a charge controlling system including a process of ejecting ink by utilizing an electrostatic attraction force; a drop-on-demand system (pressure pulse system) utilizing vibration pressure of a piezoelectric element; an acoustic inkjet system including processes of converting an electric signal to an acoustic beam, irradiating ink with the acoustic beam, and ejecting the ink utilizing radiation pressure; and a thermal inkjet system including processes of heating ink to generate bubbles, and utilizing the produced pressure. The inkjet systems include a system including a process of ejecting a large number of inks, which each have a low concentration and is referred to as a photo ink, with a small volume, a system for improving image quality using plural inks having substantially the same hue and having a different concentration from each other, or a system using a colorless transparent ink.

In the inkjet recording method of the invention, each ink of the ink set containing cyan ink and magenta ink is provided. The ink set may contain inks other than the cyan ink and the magenta ink. In particular, an aspect of providing each ink of an ink set of three or more colors (e.g., three colors of magenta ink, cyan ink, and yellow ink, four colors further including black ink in addition to the three colors, etc.) is preferable.

### EXAMPLES

Hereinafter, the invention will be described more specifically with reference to Examples but is not limited to the following Examples insofar as they do not depart from the scope of the invention. Unless otherwise specified, “part (s)” and “%” are based on mass.

Preparation of InkJet Recording Medium

### Preparation of Upper Layer Coating Liquid

A total of 42.0 kg of ion exchange water and 0.3 kg of 2.5 wt. % ammonia aqueous solution (aqueous solution of a basic compound) were added to a suction disperser CONTI-TDS (manufactured by Dalton Corp.), and then 18.1 kg of CATALOID AP-5 (pseudoboehmite alumina, primary particle size 8 nm, manufactured by Shokubai Kasei Kogyo Kabushiki Kaisha) was added by small and small while stirring at a maximum rotation speed, and a white coarse dispersion of pseudoboehmite was obtained. The dispersion time in this case was 35 minutes.

The white coarse dispersion of pseudoboehmite was finely dispersed with a high-pressure disperser (ULTIMIZER-HJP₂₅₀₀₅, manufactured by Sugino Machine KK), and a transparent pseudoboehmite dispersion with a concentration of solids of 30 wt. % was obtained. The pressure in this process was 100 MPa, and the discharge rate was 600 g/min.

A particle size of the transparent pseudoboehmite dispersion was 0.050 μm.

585 g of the obtained transparent pseudoboehmite dispersion, 186.5 g of ion exchange water, 10.8 g of diethylene glycol monobutyl ether (BUTYCENOL 20P, water-soluble high-boiling solvent, manufactured by Kyowa Hakko Chemicals Co., Ltd.), 240.7 g of poly(vinyl alcohol) with a degree of saponification of 88% and a degree of polymerization of 3500 (PVA235, manufactured by Kuraray Co., Ltd.), and 1.0 g of a 10% surfactant aqueous solution (SWANOL AM2150, manufactured by Nikko Chemicals Co., Ltd.) were each kept at 50° C. and then mixed to obtain a pseudoboehmite coating liquid (upper layer coating liquid; coating liquid B).

Preparation of Lower Layer Coating Liquid

42.3 kg of ion exchange water was added to a suction disperser CONTI-TDS (manufactured by Dalton Corp.), and 20.2 kg of CATALOID AP-5 (pseudoboehmite alumina, primary particle size 8 nm, manufactured by Shokubai Kasei Kogyo Kabushiki Kaisha) was added by small and small while stirring at a maximum rotation speed to obtain a white coarse dispersion of pseudoboehmite. The dispersion time in this case was 35 minutes.

The white coarse dispersion of pseudoboehmite was finely dispersed with a high-pressure disperser (ULTIMIZER-HJP₂₅₀₀₅, manufactured by Sugino Machine KK), and a transparent pseudoboehmite dispersion with a concentration of solids of 30 wt. % was obtained. The pressure in this process was 100 MPa, and the discharge rate was 600 g/min.

A particle size of the transparent pseudoboehmite dispersion was 0.050 μm.

585 g of the obtained transparent pseudoboehmite dispersion, 183.8 g of ion exchange water, 4.5 g of an aqueous solution of zirconium acetate (ZIRCOSOL ZA-30, manufactured by Dai-ichi Kigenso Kagaku Kogyo Co., Ltd.), 9 g of cationic polyurethane dispersion (SUPERFLEX 650-5, manufactured by Dai-ichi Kogyo Seiyaku Co., Ltd.), 240.7 g of poly(vinyl alcohol) with a degree of saponification of 88% and a degree of polymerization of 3500 (PVA235, manufactured by Kuraray Co., Ltd.), and 1.0 g of a 10% surfactant aqueous solution (SWANOL AM2150, manufactured by Nikko Chemicals Co., Ltd.) were each kept at 50° C. and then mixed to obtain a pseudoboehmite coating liquid (lower layer coating liquid; coating liquid A).

Fabrication of Substrate

A 1:1 mixture of leaf bleached Kraft pulp (LBKP) and needle bleached sulfite pulp (NBSP) was crushed to obtain 300 ml with a freeness according to a Canadian standard and prepare a pulp slurry. An alkyl ketene dimmer was added as a sizing agent at 0.5 wt. % in relation to the pulp, polyacrylamide was added as a reinforcing agent at 1.0 wt. % in relation to the pulp, cationized starch was added at 2.0 wt. % in relation to the pulp, and a polyamidoepichlorohydrin resin was added at 0.5 wt. % in relation to the pulp, followed by diluting with water. As a result, a 1% slurry was obtained. The slurry was processed at a long-mesh papermaking machine to obtain a metric weight of 170 g/m², dried to adjust the moisture level, thereby producing a base paper for a paper coated with a polyolefin resin.

A polyethylene resin composition prepared by homogeneously dispersing 10% by weight anatase-type titanium oxide in a resin having a density of 0.918 g/cm³ and containing 100 wt. % low-density polyethylene was melted at a temperature of 320° C., the melt was extrusion coated at 200 m/min on one surface of the produced base paper so as to obtain a thickness of 35 μm, and then treated with a surface-finely roughened cooling roll (this surface will be hereinafter referred to as “front surface”).

A blended resin composition including 70 parts by weight of a high-density polyethylene resin with a density of 0.962 g/cm³ and 30 parts by weight of a low-density polyethylene resin with a density of 0.918 g/cm³ was similarly melted at a temperature of 320° C., the melt was extrusion coated on the other surface of the produced base paper so as to obtain a thickness of 30 μm, and then treated with a surface-finely roughened cooling roll (this surface will be hereinafter referred to as “rear surface”).

Paper coated with a polyolefin resin in which both surfaces of a base paper were coated with the resin was thus obtained.

The front surface of the paper coated with a polyolefin resin was subjected to a high-frequency corona discharge processing, and then an undercoating layer of the below-described composition was coated and dried to obtain a metric weight of gelatin of 50 mg/m², thereby producing a substrate.

Composition of Undercoating Layer

| | |
|---|---|
| Lime-treated gelatin | 100 parts |
| 2-ethylhexyl sulfosuccinate ester salt | 2 parts |
| Chrome alum | 10 parts |

Formation of Ink-Receiving Layer

The obtained upper layer coating liquid and lower layer coating liquid were kept at 50° C., and 188 g of a 7.5% aqueous solution of boric acid kept at the same temperature was in-line added to the upper layer coating liquid, and thereafter the upper layer coating liquid and lower layer coating liquid were simultaneously multilayer coated on the undercoating layer of the substrate with a slide bead coating device in the order of the lower layer coating liquid and upper layer coating liquid from the side of the undercoating layer. The coating layers obtained by the simultaneous multilayer coating were set and dried for 2 min so as to obtain a film surface temperature of 20° C., and then drying was performed for 10 min at a temperature of 80° C. to obtain an ink-receiving layer. In this case, the coating amount of pseudoboehmite alumina in the upper layer coating liquid and the coating amount of inorganic fine particles (pseudoboehmite alumina) in the lower layer coating liquid was 19 g/m² each.

The above-described operations produced an inkjet recording medium having the ink-receiving layer on the substrate.

Preparation of Cyan Ink

Cyan inks (Inks A to E) were prepared by mixing the respective components shown in Table 1.

TABLE 1

| | | | | | Ink E |
|---|---|---|---|---|---|
| | | | | | (For |
| | Ink A | Ink B | Ink C | Ink D | comparison) |
| Cyan dye C-1 | 4.3 | 2.6 | 1.7 | — | — |
| mentioned later | | | | | |
| Cyan dye C-2 | — | 1.7 | 2.6 | 40.6 | — |
| mentioned later | | | | | |
| Cyan dye C-3 | — | — | — | — | 4.3 |
| mentioned later | | | | | |
| Ultra pure water | 38.9 | 38.9 | 38.9 | 2.6 | 38.9 |
| Aminoguanidine | 1.6 | 1.6 | 1.6 | 1.6 | 1.6 |
| hydrochloride | | | | | |
| Ultra pure water | 11.5 | 11.5 | 11.5 | 11.5 | 11.5 |
| Glycerol | 7.3 | 7.3 | 7.3 | 7.3 | 7.3 |
| Triethylene glycol | 1.4 | 1.4 | 1.4 | 1.4 | 1.4 |
| Triethylene glycol | 7.5 | 7.5 | 7.5 | 7.5 | 7.5 |
| monobutyl ether | | | | | |
| Propylene | 0.2 | 0.2 | 0.2 | 0.2 | 0.2 |
| glycol | | | | | |
| 1,2-Hexanediol | 1.0 | 1.0 | 1.0 | 1.0 | 1.0 |
| 2-pyrrolidone | 2.2 | 2.2 | 2.2 | 2.2 | 2.2 |
| Urea | 3.3 | 3.3 | 3.3 | 3.3 | 3.3 |
| Orufin E1010 | 0.8 | 0.8 | 0.8 | 0.8 | 0.8 |
| Total | 80.0 | 80.0 | 80.0 | 80.0 | 80.0 |

(part by weight)
Cyan dye C-1

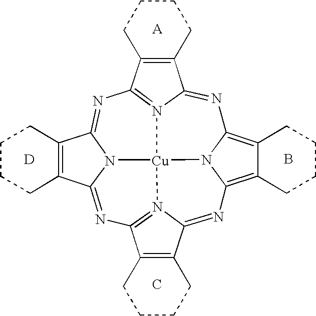

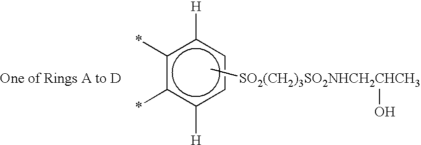

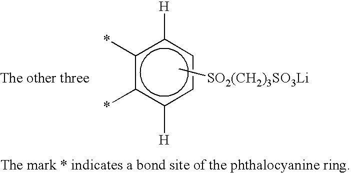

Cyan dye C-2

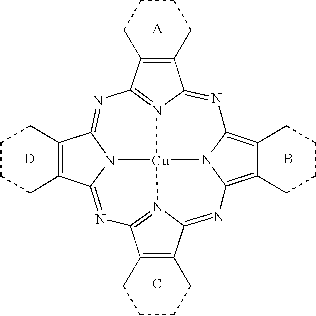

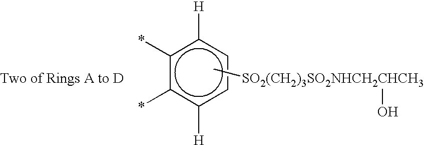

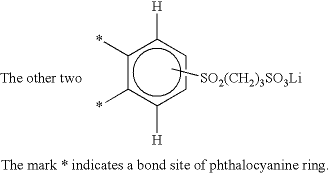

Cyan dye C-3

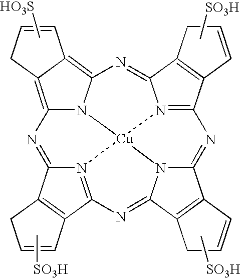

### Example 1

### Inkjet Recording and Evaluation

Inkjet recording was carried out on the inkjet recording media produced above using an inkjet printer (trade name: PM-A820, manufactured by Seiko Epson Corporation), and the following evaluation was carried out. The inkjet recording was carried while replacing a cyan ink of an ink set for PM-A820 with the ink A prepared above. More specifically, the inkjet recording was carried out using an ink set having a combination of yellow ink “Y (A820)”, magenta ink “M (A820)”, cyan ink “C (ink A)”, and black ink “K (A820)” as shown in Table 2.

The evaluations results are shown in Table 2-1.

Bronzing

A cyan solid image was printed in an atmosphere of a temperature of 13° C. and a humidity of 65% using an inkjet printer (trade name: PM-A820, manufactured by Seiko Epson Corporation) except for changing a cyan ink of an ink set for PM-A820 to the above-prepared ink A). The printed cyan solid image was observed under a fluorescent lamp, and bronzing was evaluated in accordance with the following evaluation criteria.

### —Evaluation Criteria—

A: Fluorescent light reflected by the cyan solid image does not look reddish and maintains its whiteness.
B: Fluorescent light reflected by the cyan solid image slightly looks reddish.
C: Fluorescent light reflected by the cyan solid image partially looks reddish.
D: Fluorescent light reflected by the cyan solid image entirely looks reddish.

<Print Image Density>

Yellow, magenta, cyan, and black solid images were respectively printed on the inkjet recording medium produced above using an inkjet printer (trade name: PM-A820, manufactured by Seiko Epson Corporation) except for changing a cyan ink of an ink set for PM-A820 to the above-prepared ink A).

The image density of each of the cyan (C), black (k), yellow (Y), and magenta (M) in the solid printed areas was measured under the conditions of a viewing angle of 2° and a light source of D50 by using Gretag Spectrolino SPM50 without using a filter.

Blur Due to Heat and Humidity

A thin line of each of yellow, magenta, cyan, and black was printed on the above-produced inkjet recording medium using an inkjet printer (trade name: PM-A820, manufactured by Seiko Epson Corporation) except for changing a cyan ink of an ink set for PM-A820 to the above prepared ink A). Then, the magenta thin line of a sample stored under an environment of 30° C./80% was visually observed a week later and was evaluated in terms of blur due to heat and humidity in accordance with the following evaluation criteria.

### —Evaluation Criteria—

A: No blur is visible.
B: Slight blur is visible.
C: Blur is visible.
D: Remarkable blur is visible.

Ozone Resistance

A cyan solid image was printed on the above-produced inkjet recording medium so that the cyan density was 1.0 using an inkjet printer (trade name: PM-A820, manufactured by Seiko Epson Corporation) except for changing a cyan ink of an ink set for PM-A820 to the above-prepared ink A).

The inkjet recording medium on which the solid image was printed was stored for 48 hours under the environment of ozone concentration of 10 ppm. The cyan density before and after the storage was measured with a reflection density meter (trade name: Xrite 938, manufactured by X Rite Corporation), and the cyan residual ratio (ozone resistance; unit %) was measured in accordance with the following equation.

A cyan residual ratio (ozone resistance; unit %) of 50% or more is acceptable from a practical viewpoint.

Cyan residual ratio(ozone resistance;unit %)=(Cyan density after storage/Cyan density before storage)×100

Light Fastness

A cyan solid image was printed on the above-produced inkjet recording medium so that the cyan density was 1.0 using an inkjet printer (trade name: PM-A820, manufactured by Seiko Epson Corporation) except for changing a cyan ink of an ink set for PM-A820 to the above-prepared ink A).

The inkjet recording medium on which the solid image was printed was stored for 24 hours under the environment of 23° C. and 60% R H. Then, the cyan solid image after the storage was irradiated with xenon light (trade name: ci5000, manufactured by ATLAS) having an illuminance of 75000 lux for 14 days through a filter (trade name: SC37). The cyan density before and after the irradiation was measured with a reflection density meter (trade name: Xrite 938, manufactured by X Rite Corporation), and the cyan residual ratio (light fastness; unit %) was measured in accordance with the following equation.

A cyan residual ratio (light fastness; unit %) of 65% or more is acceptable from a practical viewpoint.

Cyan residual ratio(light fastness; unit %)=(Cyan density after light irradiation/Cyan density before irradiation)×100

### Example 2

An inkjet recording medium was fabricated in the same manner as in Example 1, except that the aqueous solution of zirconium acetate (ZIRCOSOL ZA-30, manufactured by Dai-ichi Kigenso Kagaku Kogyo Co., Ltd.) was removed from the lower layer coating liquid. The evaluation was performed in the same manner as in Example 1. The evaluation results are shown in Table 2-1 below.

### Example 3

An inkjet recording medium was fabricated in the same manner as in Example 1, except that the cationic polyurethane dispersion (SUPERFLEX 650-5, manufactured by Dai-ichi Kogyo Seiyaku Co., Ltd.), was removed from the lower layer coating liquid. The evaluation was performed in the same manner as in Example 1. The evaluation results are shown in Table 2-1 below.

### Example 4

An inkjet recording medium was fabricated in the same manner as in Example 1, except that ammonia, which was a basic compound contained in the upper layer coating liquid, was replaced with the same amount of sodium acetate. The evaluation was performed in the same manner as in Example 1. The evaluation results are shown in Table 2-1 below.

### Example 5

An inkjet recording medium was fabricated in the same manner as in Example 1, except that the lower layer coating liquid was replaced with the below-described lower layer coating liquid 2 and the coating amount of pseudoboehmite alumina of the upper layer coating liquid and the coating amount of inorganic fine particles (vapor-phase silica) of the lower layer coating liquid were the coating amounts shown in Table 2. The evaluation was performed in the same manner as in Example 1. The evaluation results are shown in Table 2-1 below.

Preparation of Lower Layer Coating Liquid 2

Preparation of Vapor-Phase Silica

A dimethyldiallyl ammonium chloride homopolymer was added to a mixture of water and modified ethanol as a dispersion medium, and then vapor-phase silica was added, and then a preliminary dispersion was performed, thereby to prepare a coarse dispersion. The coarse dispersion was treated twice with a high-pressure homogenizer, and thereby a vapor-phase silica dispersion (composition is described below) with a silica concentration of 20 wt. % was prepared. An average particle diameter of vapor-phase silica was 100 nm.

Composition of Vapor-Phase Silica Dispersion

| | |
|---|---|
| Water | 430 parts |
| Modified ethanol | 22 parts |
| Cationic polymer (dimethyldiallyl ammonium chloride | 3 parts |
| homopolymer, manufactured by Dai-ichi Kogyo Seiyaku | |
| Co., Ltd., SHALLOL DC902P, average molecular weight | |
| 9000) | |
| Vapor-phase silica (average primary particle size | 100 parts |
| 7 nm, specific surface area determined by | |
| a BET method 300 m²/g) | |

Preparation of Lower Layer Coating Liquid 2

The following components were mixed and stirred to prepare the lower layer coating liquid 2.

### Composition of Lower Layer Coating Liquid

| | | |
|---|---|---|
| Vapor-phase silica dispersion obtained as described | 100 | parts |
| hereinabove (as a solid fraction of vapor-phase silica) | | |
| Boric acid | 3 | parts |
| Poly(vinyl alcohol) (degree of saponification 88%, | 22 | parts. |
| average degree of polymerization 3500) | | |
| Zirconyl acetate (ZIRCOSOL ZA-30, manufactured by | 3 | parts |
| Dai-ichi Kigenso Kagaku Kogyo Co., Ltd.) | | |
| Surfactant (betaine-type, SWANOL AM-2150, | 0.1 | parts. |
| manufactured by Japan Surfactant Co., Ltd.) | | |

### Example 6

An inkjet recording medium was fabricated in the same manner as in Example 1, except that the water-soluble high-boiling solvent (diethylene glycol monobutyl ether) contained in the upper layer coating liquid was replaced with the same amount of triethylene glycol monobutyl ether, which is a water-soluble high-boiling solvent. The evaluation was performed in the same manner as in Example 1. The evaluation results are shown in Table 2-2 below.

### Example 7

An inkjet recording medium was fabricated in the same manner as in Example 1, except that water-soluble high-boiling solvent (diethylene glycol monobutyl ether) contained in the upper layer coating liquid was replaced with the same amount of triethylene glycol monohexyl ether, which is a water-soluble high-boiling solvent. The evaluation was performed in the same manner as in Example 1. The evaluation results are shown in Table 2-2 below.

### Example 8

An upper layer coating liquid and a lower layer coating liquid were prepared in the same manner as in Example 1.

### Formation of Ink-Receiving Layer

The obtained upper layer coating liquid and lower layer coating liquid were each kept at 50° C., and 188 g of a 7.5% aqueous solution of boric acid kept at the same temperature was in-line added to the upper layer coating liquid, and thereafter the upper layer coating liquid and lower layer coating liquid were simultaneously multilayer coated on the undercoating layer of the substrate with a slide bead coating device in the order of the lower layer coating liquid and the upper layer coating liquid from the side of the undercoating layer. The coating layers obtained by the simultaneous multilayer coating were set and dried for 2 minutes so as to obtain a film surface temperature of 20° C., and then drying was performed at a temperature of 80° C. until a solid concentration in the coating layer got 40%. The coating layer showed constant-rate drying within this period.

Immediately thereafter, the coating layer dried to the concentration of solids of 40% was immersed for 3 seconds in the basic solution C of the below-described composition, and the basic solution C was applied at the amount of 13 g/m² to the coating layer. The coating layer to which the basic solution C has been applied was then dried for 10 minutes at 80° C. to obtain an ink-receiving layer.

The coating amount of pseudoboehmite alumina of the upper layer coating liquid and the coating amount of inorganic fine particles (pseudoboehmite alumina) of the lower layer coating liquid in the simultaneous multilayer coating process were each set so as to be 19 g/m².

An inkjet recording medium having an ink-receiving layer on a substrate was thus obtained.

The obtained inkjet recording medium was evaluated in the same manner as in Example 1. The evaluation results are shown in Table 2-2 below.

Composition of Basic Solution C

| | | |
|---|---|---|
| Boric acid | 0.6 | parts |
| Ammonium carbonate | 5 | parts |
| Polyoxyethylene lauryl ether (surfactant) | 0.6 | parts |
| 1.5-Naphthalenedisulfonic acid | 0.75 | parts |
| 2.5% Ammonia water | 6 | parts |
| Ion exchange waster | 85.8 | parts. |

### Example 9

An inkjet recording medium was fabricated in the same manner as in Example 8, except that the amount of 1,5-naphthalenedisulfonic acid of Example 8 was changed from 0.75 parts to 1.50 parts. The evaluation was performed in the same manner as in Example 1. The evaluation results are shown in Table 2-2 below.

### Examples 10-11

Inkjet recording media were fabricated in the same manner as in Example 1, except that the coating amount of pseudoboehmite alumina of the upper layer coating liquid and the coating amount of inorganic fine particles (pseudoboehmite alumina) of the lower layer coating liquid during formation of the ink-receiving layer in the process of Example 1 were changed as shown in Table 3 below. The evaluation was performed in the same manner as in Example 1.

The evaluation results are shown in Table 3 below.

### Comparative Example 1

An inkjet recording medium was fabricated in the same manner as in Example 1, except that diethylene glycol monobutyl ether was removed from the upper layer coating liquid. The evaluation was performed in the same manner as in Example 1. The evaluation results are shown in Table 4-1 below.

### Comparative Example 2

An inkjet recording medium was fabricated in the same manner as in Example 1, except that 2.5% by weight ammonia aqueous solution was removed from the upper layer coating liquid. The evaluation was performed in the same manner as in Example 1. The evaluation results are shown in Table 4-1 below.

### Comparative Example 3

An inkjet recording medium was fabricated in the same manner as in Example 1, except that the aqueous solution of zirconium acetate (ZIRCOSOL ZA-30, manufactured by Dai-ichi Kigenso Kagaku Kogyo Co., Ltd.) and cationic polyurethane dispersion (SUPERFLEX 650-5, manufactured by Dai-ichi Kogyo Seiyaku Co., Ltd.) were removed from the lower layer coating liquid. The evaluation was performed in the same manner as in Example 1. The evaluation results are shown in Table 4-1 below.

### Comparative Example 4

An inkjet recording medium was fabricated in the same manner as in Example 1, except that diethylene glycol monobutyl ether and 2.5% by weight ammonia aqueous solution were removed from the upper layer coating liquid and the lower layer coating liquid was replaced with the lower layer coating liquid 2 of Example 5. The evaluation was performed in the same manner as in Example 1. The evaluation results are shown in Table 4-1 below.

### Comparative Example 5

An inkjet recording medium was fabricated in the same manner as in Example 1, except that the lower layer coating liquid was not used and only the upper layer coating liquid was coated as a single layer at a coating amount of pseudoboehmite alumina of 38 g/m² in the formation of the ink-receiving layer by the process of Example 1. The evaluation was performed in the same manner as in Example 1.

The evaluation results are shown in Table 4-1 below.

### Comparative Example 6

An inkjet recording medium was fabricated in the same manner as in Example 1, except that the upper layer coating liquid was not used and only the lower layer coating liquid was coated as a single layer at a coating amount of inorganic fine particles (pseudoboehmite alumina) of 38 g/m² in the formation of the ink-receiving layer by the process of Example 1. The evaluation was performed in the same manner as in Example 1. The evaluation results are shown in Table 4-2 below.

### Comparative Example 7

An inkjet recording medium was fabricated in the same manner as in Comparative Example 5, except that SUPERFLEX 650-5 was added as a component of the upper layer coating liquid at a coating amount of 0.5 g/m². However, the evaluation was impossible due to shrinkage of the ink-receiving layer that occurred during coating and drying of the upper layer.

### Comparative Example 8

An inkjet recording medium was fabricated in the same manner as in Comparative Example 6, except that DEGMBE was added as a component of the lower layer coating liquid at a coating amount of 1.0 g/m². However, the evaluation was impossible due to shrinkage of the ink-receiving layer that occurred during coating and drying of the upper layer.

### Comparative Examples 9-10

Inkjet recording media were produced in the same manner as in Example 1, except for changing the cyan inks as shown in Table 4, and the same evaluation as in Example 1 was carried out.

The evaluation results are shown in Table 4-2.

TABLE 2-1

| | | Ex. 1 | Ex. 2 | Ex. 3 | Ex. 4 | Ex. 5 |
|---|---|---|---|---|---|---|
| Upper layer | Inorganic fine particles | Pseudo | Pseudo | Pseudo | Pseudo | Pseudo |
| | | boehmite | boehmite | boehmite | boehmite | boehmite |
| | High boiling solvent | DEGMBE | DEGMBE | DEGMBE | DEGMBE | DEGMBE |
| | Cationic polyurethane | None | None | None | None | None |
| | fine particles | | | | | |
| | Basic compound | Ammonia | Ammonia | Ammonia | Sodium acetate | Ammonia |
| | Sulfo group containing | None | None | None | None | None |
| | organic compound | | | | | |
| | Coating amount of pseudo | 19 | 19 | 19 | 19 | 19 |
| | boehmite (g/m²) | | | | | |
| Lower layer | Inorganic fine particles | Pseudo | Pseudo | Pseudo | Pseudo | Silica |
| | | boehmite | boehmite | boehmite | boehmite | |
| | High boiling solvent | None | None | None | None | None |
| | Cationic polyurethane | SUPERFLEX | SUPERFLEX | None | SUPERFLEX | None |
| | fine particles | 650-5 | 650-5 | | 650-5 | |
| | Zirconium salt | ZIRCOZOL | None | ZIRCOZOL | ZIRCOZOL | ZIRCOZOL |
| | | ZA-30 | | ZA-30 | ZA-30 | ZA-30 |
| | Coating amount of inorganic | 19 | 19 | 19 | 19 | 9 |
| | fine particles (g/m²) | | | | | |
| Ink set | Y (A820) | B | B | B | B | B |
| | M (A820) | B | B | B | B | B |
| | C (Ink A) | B | B | B | B | B |
| | C (Ink B) | — | — | — | — | — |
| | C (Ink C) | — | — | — | — | — |
| | C (Ink D) | — | — | — | — | — |
| | C (Ink E) | — | — | — | — | — |
| | K (A820) | B | B | B | B | B |
| Evaluation | Bronzing (C) | B | B | B | B | B |
| results | Print image density (Y) | 1.65 | 1.65 | 1.62 | 1.62 | 1.63 |
| | Print image density (M) | 1.05 | 1.05 | 1.05 | 1.04 | 1.03 |
| | Print image density (C) | 0.48 | 0.49 | 0.49 | 0.50 | 0.50 |
| | Print image density (K) | 2.95 | 2.96 | 2.96 | 2.96 | 2.95 |
| | Blur due to heat and | A | B | C | B | C |
| | humidity (M) | | | | | |
| | Ozone resistance/Light | 72%/91% | 72%/91% | 73%/91% | 73%/91% | 73%/91% |
| | fastness (C) | | | | | |

TABLE 2-2

| | | Ex. 6 | Ex. 7 | Ex. 8 | Ex. 9 |
|---|---|---|---|---|---|
| Upper layer | Inorganic fine particles | Pseudo | Pseudo | Pseudo | Pseudo |
| | | boehmite | boehmite | boehmite | boehmite |
| | High boiling solvent | TEGMBE | DEGMHE | DEGMBE | DEGMBE |
| | Cationic polyurethane | None | None | None | None |
| | fine particles | | | | |
| | Basic compound | Ammonia | Ammonia | Ammonia | Ammonia |
| | Sulfo group containing | None | None | Naphthalene | Naphthalene |
| | organic compound | | | disulfonic | disulfonic |
| | | | | acid (0.1 g/m²) | acid (0.2 g/m²) |
| | Coating amount of pseudo | 19 | 19 | 19 | 19 |
| | boehmite (g/m²) | | | | |
| Lower layer | Inorganic fine particles | Pseudo | Pseudo | Pseudo | Pseudo |
| | | boehmite | boehmite | boehmite | boehmite |
| | High boiling solvent | None | None | None | None |
| | Cationic polyurethane | SUPERFLEX | SUPERFLEX | SUPERFLEX | SUPERFLEX |
| | fine particles | 650-5 | 650-5 | 650-5 | 650-5 |
| | Zirconium salt | ZIRCOZOL | ZIRCOZOL | ZIRCOZOL | ZIRCOZOL |
| | | ZA-30 | ZA-30 | ZA-30 | ZA-30 |
| | Coating amount of inorganic | 19 | 19 | 19 | 19 |
| | fine particles (g/m²) | | | | |
| Ink set | Y (A820) | B | B | B | B |
| | M (A820) | B | B | B | B |
| | C (Ink A) | B | B | B | B |
| | C (Ink B) | — | — | — | — |
| | C (Ink C) | — | — | — | — |
| | C (Ink D) | — | — | — | — |
| | C (Ink E) | — | — | — | — |
| | K (A820) | B | B | B | B |
| Evaluation | Bronzing (C) | B | B | B | B |
| results | Print image density (Y) | 1.65 | 1.65 | 1.64 | 1.66 |
| | Print image density (M) | 1.05 | 1.05 | 1.05 | 1.06 |
| | Print image density (C) | 0.50 | 0.50 | 0.50 | 0.50 |
| | Print image density (K) | 2.95 | 2.95 | 2.95 | 2.95 |
| | Blur due to heat and | A | A | A | A |
| | humidity (M) | | | | |
| | Ozone resistance/Light | 73%/91% | 73%/91% | 75%/91% | 78%/91% |
| | fastness (C) | | | | |

TABLE 3

| | | Ex. 10 | Ex. 11 | Ex. 12 | Ex. 13 | Ex. 14 |
|---|---|---|---|---|---|---|
| Upper layer | Inorganic fine particles | Pseudo | Pseudo | Pseudo | Pseudo | Pseudo |
| | | boehmite | boehmite | boehmite | boehmite | boehmite |
| | High boiling solvent | DEGMBE | DEGMBE | DEGMBE | DEGMBE | DEGMBE |
| | Cationic polyurethane | None | None | None | None | None |
| | fine particles | | | | | |
| | Basic compound | Ammonia | Ammonia | Ammonia | Ammonia | Ammonia |
| | Sulfo group containing | None | None | None | None | None |
| | organic compd. | | | | | |
| | Coating amount of pseudo | 9.5 | 4.6 | 19 | 19 | 19 |
| | boehmite g/m² | | | | | |
| Lower layer | Inorganic fine particles | Pseudo | Pseudo | Pseudo | Pseudo | Pseudo |
| | | boehmite | boehmite | boehmite | boehmite | boehmite |
| | High boiling solvent | None | None | None | None | None |
| | Cationic polyurethane | SUPERFLEX | SUPERFLEX | SUPERFLEX | SUPERFLEX | SUPERFLEX |
| | fine particles | 650-5 | 650-5 | 650-5 | 650-5 | 650-5 |
| | Zirconium salt | ZIRCOZOL | ZIRCOZOL | ZIRCOZOL | ZIRCOZOL | ZIRCOZOL |
| | | ZA-30 | ZA-30 | ZA-30 | ZA-30 | ZA-30 |
| | Coating amount of inorganic | 28.5 | 33.4 | 19 | 19 | 19 |
| | fine particles (g/m²) | | | | | |
| Ink set | Y (A820) | B | B | B | B | B |
| | M (A820) | B | B | B | B | B |
| | C (Ink A) | B | B | — | — | — |
| | C (Ink B) | — | — | B | — | — |
| | C (Ink C) | — | — | — | B | — |
| | C (Ink D) | — | — | — | — | B |
| | C (Ink E) | — | — | — | — | — |
| | K (A820) | B | B | B | B | B |
| Evaluation | Bronzing (C) | C | C | B | B | C |
| results | Print image density (Y) | 1.62 | 1.62 | 1.63 | 1.65 | 1.65 |
| | Print image density (M) | 1.05 | 1.04 | 1.03 | 1.05 | 1.05 |
| | Print image density (C) | 0.49 | 0.49 | 0.49 | 0.49 | 0.49 |
| | Print image density (K) | 2.96 | 2.96 | 2.95 | 2.95 | 2.95 |
| | Blur due to heat and | A | A | A | A | A |
| | humidity (M) | | | | | |
| | Ozone resistance/Light | 72%/91% | 72%/91% | 70%/85% | 65%/80% | 75%/95% |
| | fastness (C) | | | | | |

TABLE 4-1

| | | Comp. Ex. 1 | Comp. Ex. 2 | Comp. Ex. 3 | Comp. Ex. 4 | Comp. Ex. 5 |
|---|---|---|---|---|---|---|
| Upper layer | Inorganic fine particles | Pseudo | Pseudo | Pseudo | Pseudo | Pseudo |
| | | boehmite | boehmite | boehmite | boehmite | boehmite |
| | High boiling solvent | None | DEGMBE | DEGMBE | None | DEGMBE |
| | Cationic polyurethane | None | None | None | None | None |
| | fine particles | | | | | |
| | Basic compound | Ammonia | None | Ammonia | None | Ammonia |
| | Sulfo group containing | None | None | None | None | None |
| | organic compound | | | | | |
| | Coating amount of pseudo | 19 | 19 | 19 | 19 | 38 |
| | boehmite (g/m²) | | | | | |
| Lower layer | Inorganic fine particles | Pseudo | Pseudo | Pseudo | Silica | — |
| | | boehmite | boehmite | boehmite | | |
| | High boiling solvent | None | None | None | None | — |
| | Cationic polyurethane | SUPERFLEX | SUPERFLEX | None | None | — |
| | fine particles | 650-5 | 650-5 | | | |
| | Zirconium salt | ZIRCOZOL | ZIRCOZOL | None | ZIRCOZOL | — |
| | | ZA-30 | ZA-30 | | ZA-30 | |
| | Coating amount of inorganic | 19 | 19 | 19 | 9 | 0 |
| | fine particles | | | | | |
| Ink set | Y (A820) | B | B | B | B | B |
| | M (A820) | B | B | B | B | B |
| | C (Ink A) | B | B | B | B | B |
| | C (Ink B) | — | — | — | — | — |
| | C (Ink C) | — | — | — | — | — |
| | C (Ink D) | — | — | — | — | — |
| | C (Ink E) | — | — | — | — | — |
| | K (A820) | B | B | B | B | B |
| Evaluation | Bronzing (C) | D | D | B | D | B |
| results | Image printing density (Y) | 1.60 | 1.60 | 1.65 | 1.64 | 1.65 |
| | Image printing density (M) | 1.06 | 1.00 | 1.10 | 1.05 | 1.05 |
| | Image printing density (C) | 0.50 | 0.50 | 0.50 | 0.50 | 0.49 |
| | Image printing density (K) | 2.97 | 2.97 | 2.98 | 2.99 | 2.97 |
| | Blur due to heat and | A | A | C | B | C |
| | humidity (M) | | | | | |
| | Ozone resistance/Light | 72%/91% | 72%/91% | 72%/91% | 72%/91% | 72%/91% |
| | fastness (C) | | | | | |

TABLE 4-2

| | | Comp. Ex. 6 | Comp. Ex. 7 | Comp. Ex. 8 | Comp. Ex. 9 | Comp. Ex. 10 |
|---|---|---|---|---|---|---|
| Upper layer | Inorganic fine particles | — | Pseudo | — | Pseudo | Pseudo |
| | | | boehmite | | boehmite | boehmite |
| | High boiling solvent | — | DEGMBE | — | DEGMBE | None |
| | Cationic polyurethane | — | SUPERFLEX | — | None | None |
| | fine particles | | 650-5 | | | |
| | Basic compound | — | Ammonia | — | Ammonia | Ammonia |
| | Sulfo group containing | — | None | — | None | None |
| | organic compound | | | | | |
| | Coating amount of pseudo | 0 | 38 | 0 | 19 | 19 |
| | boehmite (g/m²) | | | | | |
| Lower layer | Inorganic fine particles | Pseudo | — | Pseudo | Pseudo | Pseudo |
| | | boehmite | | boehmite | boehmite | boehmite |
| | High boiling solvent | None | — | DEGMBE | None | None |
| | Cationic polyurethane | SUPERFLEX | — | SUPERFLEX | SUPERFLEX | SUPERFLEX |
| | fine particles | 650-5 | | 650-5 | 650-5 | 650-5 |
| | Zirconium salt | ZIRCOZOL | — | ZIRCOZOL | ZIRCOZOL | ZIRCOZOL |
| | | ZA-30 | | ZA-30 | ZA-30 | ZA-30 |
| | Coating amount of inorganic | 38 | 0 | 38 | 19 | 19 |
| | fine particles | | | | | |
| Ink set | Y (A820) | B | Unevaluable | Unevaluable | B | B |
| | M (A820) | B | due to | due to | B | B |
| | C (Ink A) | B | shrinkage | shrinkage | — | — |
| | C (Ink B) | — | during | during | — | — |
| | C (Ink C) | — | drying of | drying of | — | — |
| | C (Ink D) | — | coating | coating | — | — |
| | C (Ink E) | — | | | B | B |
| | K (A820) | B | | | B | B |
| Evaluation | Bronzing (C) | D | | | B | C |
| results | Print image density (Y) | 1.58 | | | 1.65 | 1.60 |
| | Print image density (M) | 1.02 | | | 1.05 | 1.06 |
| | Print image density (C) | 0.47 | | | 0.49 | 0.50 |
| | Print image density (K) | 2.85 | | | 2.95 | 2.97 |
| | Blur due to heat and | A | | | A | A |
| | humidity (M) | | | | | |
| | Ozone resistance/Light | 60%/91% | | | 48%/60% | 48%/60% |
| | fastness (C) | | | | | |

—Description of abbreviations in Tables 2 to 4—

DEGMBE Diethylene glycol monobutyl ether

TEGMBE Triethylene glycol monobutyl ether

DEGMHE Diethylene-glycol monohexyl ether

“Y (A820)” and the like represent “Color (Printer name).”

As shown in Tables 2-1 to 4-2, in Examples 1 to 14 in which inkjet recording was carried out using the ink set having magenta ink and cyan ink containing a cyan dye containing 50% by mass or more of the compound represented by Formula (C-1) on the inkjet recording medium containing, in the upper layer, pseudo boehmite alumina, a binder, and a water-soluble high boiling solvent and containing, in the lower layer, inorganic fine particles, a binder, and cationic polyurethane and/or a zirconium salt, print image densities were excellent, both blur and bronzing were suppressed, and both ozone resistance and light fastness were excellent.

In contrast, in Comparative Example 1 wherein no water-soluble high boiling solvent was contained in the upper layer, Comparative Example 2 wherein no basic compound was contained in the upper layer, and Comparative Example 4 wherein neither water-soluble high boiling solvent nor basic compound were contained in the upper layer, bronzing deteriorated. In Comparative Example 3 wherein neither cationic polyurethane nor zirconium salt were contained in the lower layer, blur deteriorated.

In Comparative Examples 5 to 8 wherein a single ink receiving layer was used, blur or bronzing deteriorated or shrinkage occurred during coating and drying of the ink receiving layer so that evaluation could not be carried out.

In Comparative Examples 9 to 10 wherein the cyan ink (ink E) containing a cyan dye containing the compound represented by Formula (C-1) in a proportion of lower than 50% by mass was used, both ozone resistance and light fastness deteriorated.

All publications, patent applications, and technical standards mentioned in this specification are herein incorporated by reference to the same extent as if each individual publication, patent applications, or technical standards was specifically and individually indicated to be incorporated by reference.

What is claimed is:

1. An inkjet recording method, comprising:
recording an image by an inkjet system using an ink set having a magenta ink and a cyan ink comprising a cyan dye containing 50 mass % or more of a compound represented by the following Formula (C-1) on an inkjet recording medium having at least two ink receiving layers provided on or above a substrate, wherein
at least one layer of the at least two ink receiving layers comprises a basic compound,
an uppermost layer that is farthest from the substrate among the at least the two ink receiving layers comprises pseudo boehmite alumina, a binder, and a water-soluble high-boiling solvent, and
a lower layer provided between the uppermost layer and the substrate comprises inorganic fine particles, a binder, and at least one of a cationic polyurethane or a zirconium salt 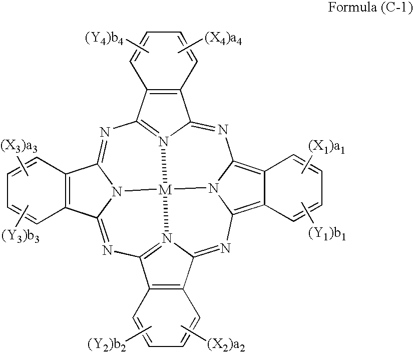
wherein, in Formula (C-1), X₁, X₂, X₃, and X₄ each independently represent —SO—Z, —SO₂—Z, —SO₂NV₁V₂, —CONV₁V₂, —CO₂Z, —CO—Z, or a sulfo group; Z′s each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group; V₁ and V₂ may be the same or different and each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group; Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; a₁ to a₄ and b₁ to b₄ each represent the number of substituents of X₁ to X₄ and Y₁ to Y₄, respectively, provided that a₁ to a₄ each independently represent an integer of from 0 to 4 and are not all 0 at the same time and b₁ to b₄ each independently represent an integer of from 0 to 4; M represents a hydrogen atom, a metal atom, oxides thereof, hydroxides thereof, or halides thereof, provided that at least one of X₁, X₂, X₃, X₄, Y₁, Y₂, Y₃, or Y₄ is an ionic hydrophilic group or a group having an ionic hydrophilic group as a substituent.

2. The inkjet recording method of claim 1, wherein the basic compound is contained in the uppermost layer that is farthest from the substrate.

3. The inkjet recording method of claim 1, wherein at least one of the at least two ink receiving layers comprises an organic compound having a sulfo group.

4. The inkjet recording method of claim 3, wherein the organic compound having a sulfo group comprises a naphthalene ring.

5. The inkjet recording method of claim 1, wherein the compound represented by the above-described Formula (C-1) is a compound represented by the following Formula (C-2) or a salt thereof 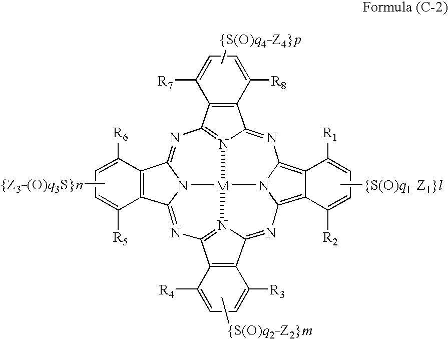
wherein, in Formula (C-2), R₁, R₂, R₃, R₄, R₅, R₆, R₇, and R₈ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryl oxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group; Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, provided that at least one of Z₁, Z₂, Z₃, or Z₄ has an ionic hydrophilic group as a substituent; l, m, n, p, q₁, q₂, q₃, and q₄ each independently represent an integer of 1 or 2; and M is the same as M in Formula (C-1).

6. The inkjet recording method of claim 5, wherein the compound represented by the above-described Formula (C-2) is a compound represented by the following Formula (C-3) or a salt thereof 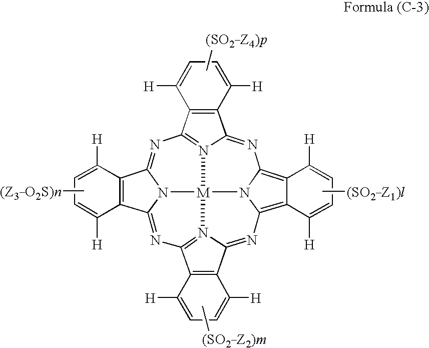
wherein, in Formula (C-3), Z₁, Z₂, Z₃, Z₄, l, m, n, p, and M are each the same as Z₁, Z₂, Z₃, Z₄, m, n, p, and M, respectively, in Formula (C-2).

7. The inkjet recording method of claim 6, wherein, in Formula (C-3), l, m, n, and p each independently represents an integer of 1 or 2 and at least two of l, m, n, and p are 1.

8. The inkjet recording method of claim 6, wherein, in Formula (C-3) l, m, n, and p are each 1.

9. The inkjet recording method of claim 6, wherein, in Formula (C-3), Z₁, Z₂, Z₃, and Z₄ each independently represent Z₁₁ which represents —(CH₂)₃SO₃M₂, where M₂ represents an alkali metal atom, or Z₁₂ which represents —(CH₂)₃SO₂NHCH₂CH(OH)CH₃.

10. The inkjet recording method of claim 6, wherein, in Formula (C-3), M is Cu, and M₂ is Li.

11. The inkjet recording method of claim 1, wherein no cationic polyurethane is contained in the uppermost layer that is farthest from the substrate.

12. The inkjet recording method of claim 1, wherein no water-soluble high-boiling solvent is contained in the lower layer among the at least the two ink receiving layers.
